(19) United States
(12) Patent Application Publication
(10) Pub. No.: US 2025/0330874 A1
(43) Pub. Date: Oct. 23, 2025

(54) FIRST NODE AND METHODS PERFORMED THEREBY FOR HANDLING TRANSFER OF GROUPS OF DEVICES

(71) Applicant: Telefonaktiebolaget LM Ericsson (publ), Stockholm (SE)

(72) Inventors: Athanasios KARAPANTELAKIS, Solna (SE); Maxim TESLENKO, Sollentuna (SE); Lackis ELEFTHERIADIS, Valbo (SE); Peter VADERNA, Budapest (HU); Agustín VALENCIA, Linköping (SE)

(21) Appl. No.: 18/870,042

(22) PCT Filed: Oct. 12, 2022
(86) PCT No.: PCT/SE2022/050919

§ 371 Date: Nov. 27, 2024

(30) Foreign Application Priority Data
Jun. 15, 2022 (GR) 20220100493

(51) Int. Cl. H04W 28/086; H04L 41/16

(52) U.S. Cl. CPC H04W 28/086; H04L 41/16

(57) ABSTRACT

A computer-implemented method, performed by a first node. The first node determines, using machine learning, one or more first groups of devices, out of a plurality of groups of devices. The one or more first groups of devices are to be transferred from a first network node operating with a first communication access technology to one or more second network nodes operating with a second communication access technology. Each of the groups the plurality has one or more respective policies pertaining to quality of service for device connection. The determining is based on the one or more first groups of devices having a highest probability to have their one or more respective policies satisfied in the second communication access technology. The first node sends an indication of the result of the determination.

### TECHNICAL FIELD

The present disclosure relates generally to a first node and methods performed thereby for handling groups of devices. The present disclosure further relates generally to computer programs and computer-readable storage mediums, having stored thereon the computer programs to carry out these methods.

### BACKGROUND

Computer systems in a communications network or system may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g., a Radio Base Station (RBS), which sometimes may be referred to as e.g., Fifth Generation (5G) Node B (gNB), evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also comprise network nodes which may serve receiving nodes, such as user equipments, with serving beams.

User Equipments (UEs) within the communications network may be e.g., devices, wireless devices, stations (STAs), mobile terminals, wireless terminals, terminals, and/or Mobile Stations (MS). UEs may be understood to be enabled to communicate wirelessly in a cellular communications network or wireless communication network, sometimes also referred to as a cellular radio system, cellular system, or cellular network. The communication may be performed e.g., between two UEs, between a wireless device and a regular telephone and/or between a wireless device and a server via a Radio Access Network (RAN) and possibly one or more core networks, comprised within the wireless communications network. UEs may further be referred to as mobile telephones, cellular telephones, laptops, or tablets with wireless capability, just to mention some further examples. The UEs in the present context may be, for example, portable, pocket-storable, hand-held, computer-comprised, or vehicle-mounted mobile devices, enabled to communicate voice and/or data, via the RAN, with another entity, such as another terminal or a server.

In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the user equipment. The so-called 5G system, from a radio perspective started to be standardized in 3GPP, and the so-called New Radio (NR) is the name for the radio interface. NR architecture is being discussed in 3GPP. In the current concept, gNB denotes an NR BS, where one NR BS may correspond to one or more transmission/reception points. The expression Uplink (UL) may be used for the transmission path in the opposite direction i.e., from the wireless device to the base station.

Wireless fidelity (Wi-Fi) offloading may be understood to refer to a collection of approaches wherein a mobile device may use Wi-Fi “hotspots” instead of cellular connection. The assumption may be understood to be that both cellular and Wi-Fi connectivity exist in the area where the device is located, and the device may also be capable of connecting to both radio access technologies. In the state of art, there are several approaches to Wi-Fi offloading that may be based on different criteria such as network congestion on the cellular network [1], energy-efficiency [2], delay sensitivity [3] and monetary cost [4].

From a mobile standards perspective, there are several ways which may be used for Wi-Fi access to be used as replacement or complement to cellular traffic. Unlicensed Mobile Access (UMA) may allow for operators to provide Internet Protocol (IP) access to their mobile networks. Applications that support UMA may need to be implemented both by the operator and the device manufacturer. One service based on UMA is Wi-Fi calling, or voice over Wi-Fi (VoWiFi), which may allow calls and messaging over Wi-Fi rather than cellular. Access Traffic Steering, Switching and Splitting (ATSSS) may be understood to define a set of steering rules which may be used to steer traffic between Wi-Fi and cellular 5G networks, perform handover without service interruption from Wi-Fi and cellular without interruption, that is, switching, or simultaneously use both Wi-Fi and cellular, that is, splitting, [5]. LTE-WLAN aggregation (LWA) is another technology where Wi-Fi Access Points (APs) may interact with LTE evolved Node Bs (eNBs) to split traffic between LTE and Wi-Fi [6].

Existing methods may also allow mobile devices connected to a cellular network to access Wi-Fi in case the throughput of the latter may be higher than that of the former. The mobility management node in 4G of the mobile core network, the Mobile Management Entity (MME), may retrieve average throughput per cell for idle and connected mobile devices and send it to a controller. Similarly, the controller may estimate the throughput that may be offered to a User Equipment (UE) [7].

Existing methods of offloading mobile devices between different access technologies, such as between cellular and WiFi, may require high computing resources and additionally fail to meet performance requirements for the devices involved.

### SUMMARY

As part of the development of embodiments herein, one or more challenges with the existing technology will first be identified and discussed.

In state of art of Wi-Fi offloading, mobile devices may be transferred between cellular and Wi-Fi independently of the service that they may belong to. This may create issues in a multi-service network such as 5G, where different devices may belong to different services that may have different network requirements. For example, Wi-Fi has no concept of Quality of Service (QoS). That is, it cannot prioritize data traffic for one application over the other. In addition, it operates in unlicensed spectrum, which may be understood to mean that data traffic may be susceptible to interference from external sources, such as, for example, other Wi-Fi networks or STAs, that may be operating in the same frequency. In a multi-service environment, where different services may have different QoS requirements, both unpredicted, that is, unplanned, interference and lack of a prioritization mechanism may severely limit the capabilities of the network to fulfil the requirements for those services.

According to the foregoing, it is an object of embodiments herein to improve the handling of groups of devices in a communications system.

According to a first aspect of embodiments herein, the object is achieved by a computer-implemented method, performed by a first node. The method is for handling groups of devices. The first node operates in a communications system. The first node determines, using machine learning, one or more first groups of devices, out of a plurality of groups of devices. The one or more first groups of devices are to be transferred from a first network node operating with a first communication access technology to one or more second network nodes operating with a second communication access technology. Each of the groups of devices in the plurality of groups of devices has one or more respective policies pertaining to quality of service for device connection. The determining is based on the one or more first groups of devices having a highest probability, out of the plurality of groups of devices, to have their one or more respective policies satisfied in the second communication access technology. The first node also sends an indication of the result of the determination to at least one of: the first network node, the one or more second network nodes, one or more of the devices in the one or more first groups of devices and another node operating in the communications system.

According to a second aspect of embodiments herein, the object is achieved by the first node, for handling groups of devices. The first node is configured to operate in the communications system. The first node is further configured to, determine, using machine learning, the one or more first groups of devices, out of the plurality of groups of devices, to be transferred from the first network node configured to operate with the first communication access technology to the one or more second network nodes configured to operate with the second communication access technology. Each of the groups of devices in the plurality of groups of devices is configured to have the one or more respective policies configured to pertain to quality of service for device connection. The determining of the one or more first groups of devices is configured to be based on the one or more first groups of devices having the highest probability, out of the plurality of groups of devices, to have their one or more respective policies satisfied in the second communication access technology. The first node is further configured to send the indication of the result of the determination to at least one of: the first network node, the one or more second network nodes, the one or more of the devices in the one or more first groups of devices and the another node configured to operate in the communications system.

According to a third aspect of embodiments herein, the object is achieved by a computer program, comprising instructions which, when executed on at least one processor, cause the at least one processor to carry out the method performed by the first node.

According to a fourth aspect of embodiments herein, the object is achieved by a computer-readable storage medium, having stored thereon the computer program, comprising instructions which, when executed on at least one processor, cause the at least one processor to carry out the method performed by the first node.

By determining the one or more first groups of devices, first node may be enabled to identify the groups of devices that may need to be offloaded from the first communication access technology to the second communication access technology based on their respective policies, while ensuring that such respective policies may be continued to be satisfied after the offloading, either at the first network node, or at the one or more second network nodes.

Furthermore, for the embodiments wherein e.g., an artificial neural network may be trained, e.g., with RL, by determining the one or more first groups of devices, first node may be enabled to reduce the dimensions of the input and output space, making the artificial neural network independent to the number and identity of devices that may be currently attached to a cell. This may be understood to allow for faster training of an agent that may be performing the training, as well as better scalability to different types of environments.

By the first node then sending the indication, the first node may enable to manage the offloading of devices from the first communication access technology to the second communication access technology, considering the requirements of quality of service the devices may have. The indication may for example, instruct the transfer of the one or more first groups of devices.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications system, according to embodiments herein.

FIG. 2 is a flowchart depicting embodiments of a method in a first node, according to embodiments herein.

FIG. 3 is a flowchart depicting a non-limiting example of the method performed by the first node, according to embodiments herein.

FIG. 4 is a signalling diagram depicting a non-limiting example of a method in a communications system, according to embodiments herein.

FIG. 5 is a schematic diagram depicting a non-limiting example of a communications system 100 and selected actions performed by the first node, according to embodiments herein.

FIG. 6 is a signalling diagram depicting another non-limiting example of a method in a communications system, according to embodiments herein.

FIG. 7 is a signalling diagram depicting a further non-limiting example of a method in a communications system, according to embodiments herein.

FIG. 8 is a signalling diagram depicting yet another non-limiting example of a method in a communications system, according to embodiments herein.

FIG. 9 is a schematic block diagram illustrating two non-limiting examples, a) and b), of a first node, according to embodiments herein.

### DETAILED DESCRIPTION

Certain aspects of the present disclosure and their embodiments address the challenges identified in the Background and Summary sections with the existing methods and provide solutions to the challenges discussed.

Embodiments herein may may be understood to overcome the challenges of the existing methods by determining a method of performing either partial or complete transfer of traffic of a mobile device from a cellular network to Wi-Fi network and vice versa, based on whether the policies of the mobile device may be violated. “Policies”, in context of embodiments herein may be understood to refer to several key performance indicators (KPIs) that may describe the quality of service of a wireless channel, cellular or Wi-Fi, such as packet drop rate, latency ceiling, guaranteed bit rate, and level of throughput on uplink or downlink, and relative priority.

As a summarized overview, embodiments herein may be understood to relate to policy-based Wi-Fi offloading for 3GPP cellular networks. More particularly, to solve the problems of the existing solutions, embodiments herein may provide a novel approach to performing policy-based transfer of mobile device data traffic from one radio access technology (RAT) to another. The preferred implementation of the embodiments herein may be between a cellular RAT, e.g., 5G NR, 4G, and Wi-Fi. The transfer may be partial, which may be referred to herein as “splitting” embodiments, or full, which may be referred to herein as “switching” embodiments, and on one or both directions, e.g., uplink and/or downlink. According to embodiments herein, a function may continuously perform clustering of the cellular mobile devices based on their policy profiles, data traffic and mobility and may monitor the quality of Wi-Fi channels and other Access Point (AP) properties.

When triggered by an issue such as congestion or an external event, e.g., by the mobile operator itself, the method may use a classifier neural network to indicate the cluster or clusters of mobile devices that may be more likely to have their policies satisfied if they joined the Wi-Fi network. To improve accuracy and reduce training time of a deep reinforcement learning (RL) algorithm, which may be used in some embodiments herein, federate learning across multiple locations using secure model aggregation may be used in some embodiments.

Embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

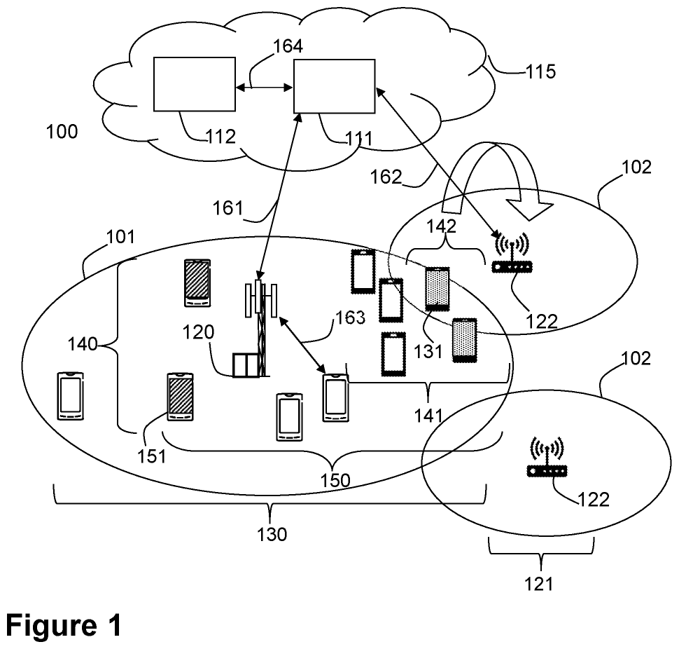

FIG. 1 depicts a non-limiting example of a communications system 100 in which embodiments herein may be implemented. The communications system 100 may be a telecommunications system, sometimes also referred to as a telecommunications network, cellular radio system, cellular network or wireless communications system. In some examples, the communications system 100 may for example be a network such as 5G system, e.g., 5G New Radio (NR), an LTE network, e.g. LTE Frequency Division Duplex (FDD), LTE Time Division Duplex (TDD), LTE Half-Duplex Frequency Division Duplex (HD-FDD), LTE operating in an unlicensed band, or a newer system supporting similar functionality. The communications system 100 may also support other technologies, such as, e.g., Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The communications system 100 may for example support a Low Power Wide Area Network (LPWAN). LPWAN technologies may comprise Long Range physical layer protocol (LoRa), Haystack, SigFox, LTE-M, and Narrow-Band IoT (NB-IoT). According to the foregoing, the communications system 100 may support a first communication access technology 101 and a second communication access technology 102. The first communication access technology 101 may be understood to be different from the second communication access technology 102. The first communication access technology 101 may be, for example a cellular technology, such as 4G or 5G. The second communication access technology 102 may be, e.g., a fixed technology, such as e.g., WiFi.

The communications system 100 may comprise a plurality of nodes, whereof a first node 111, and another node 112 or second node 112 are depicted in FIG. 1. Any of the first node 111 and the second node 112 may be understood, respectively, as a first computer system and a second computer system. In some examples, any of the first node 111 and the second node 112 may be implemented as a standalone server in e.g., a host computer in the cloud 115, as depicted in the non-limiting example depicted in FIG. 1. Any of the first node 111 and the second node 112 may in some examples be a distributed node or distributed server, with some of their respective functions being implemented locally, e.g., by a client manager, and some of its functions implemented in the cloud 115, by e.g., a server manager. Yet in other examples, any of the first node 111 and the second node 112 may also be implemented as processing resources in a server farm.

In some embodiments, any of the first node 111 and the second node 112 may be independent and separated nodes. In some embodiments, any of the first node 111 and the second node 112 may be one of: co-localized and the same node. All the possible combinations are not depicted in FIG. 1 to simplify the Figure.

It may be understood that the communications system 100 may comprise more nodes than those represented in FIG. 1.

In some examples of embodiments herein, the first node 111 may be understood as a node having a capability to gather data from a data producer of a data source and analyze the data with machine learning, that is, to execute and/or train a predictive ML model using ML. A non-limiting example of the first node 111 may be, for example, an OAM or a NWDAF entity in a 3GPP network, but also in other types of networks such as public/private infrastructures.

The second node 112 may be a node having a capability to manage mobility events for devices such as the plurality of devices 130 described below, e.g., UEs.

The communications system 100 may comprise one or more network nodes, whereof a first network node 120 is depicted in panel b) of FIG. 1. The first network node 120 may typically be. a base station or Transmission Point (TP), or any other network unit capable to serve a wireless device or a machine type node in the communications system 100. The first network node 120 may be e.g., a 5G gNB, a 4G eNB, or a radio network node in an alternative 5G radio access technology. The first network node 120 may be e.g., a Wide Area Base Station, Medium Range Base Station, Local Area Base Station and Home Base Station, based on transmission power and thereby also coverage size. The first network node 120 may be a stationary relay node or a mobile relay node. The first network node 120 may support one or several communication technologies, and its name may depend on the technology and terminology used. The first network node 120 may be directly connected to one or more networks and/or one or more core networks.

The first network node 120 may operate with the first communication access technology 101. The communications system 100 may further comprise a set of second network nodes 121. The set of second network nodes 121 may comprise one or more second network nodes 122. The one or more second network nodes 122 may operate on the second communication access technology 102.

The communications system 100 may cover a geographical area, which in some embodiments may be divided into cell areas, wherein each cell area may be served by a network node, although, one network node may serve one or several cells. The first network node 120 may serve a first cell. Each of the one or more second network nodes 122 may serve a respective second cell. Any of the first network node 120 and the one or more second network nodes 122 may be of different classes, such as, e.g., macro eNodeB, home eNodeB or pico base station, based on transmission power and thereby also cell size. In some examples, any of the first network node 120 and the one or more second network nodes 122 may serve receiving nodes with serving beams. Any of the first network node 120 and the one or more second network nodes 122 may support one or several communication technologies, and its name may depend on the technology and terminology used. Any of the first network node 120 and the one or more second network nodes 122 that may be comprised in the communications system 100 may be directly connected to one or more core networks.

The communications system 100 may comprise a plurality of devices 130. The plurality of devices 130 is served by the first network node 120. It may be understood that the number of devices in depicted in FIG. 1 is not limiting. Fewer or additional devices may be present in other examples. Any of the devices in the plurality of devices 130 may be also known as e.g., user equipment (UE), a wireless device, mobile terminal, wireless terminal and/or mobile station, mobile telephone, cellular telephone, laptop with wireless capability, a Customer Premises Equipment (CPE), an Internet of Things (IoT) device, or a sensor, just to mention some further examples. Any of the devices in the plurality of devices 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the devices in the plurality of devices 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The plurality of devices 130 may comprise, as will be explained later, a plurality of groups of devices 140. The plurality of groups of devices 140 may comprise one or more first groups of devices 141. The one or more first groups of devices 141 may comprise one or more devices 131. Out of the one or more devices 131, one or more first devices 142 may be selected for transfer, that is, offload, from the first communications access technology 101 to the second communication access technology 102, as will be explained later. The plurality of devices 130 may be filtered, as will be explained later, so that a filtered plurality of devices 150 may be left. The plurality of groups of devices 140 may comprise groups of devices 151.

The first node 111 may communicate with the first network node 120 over a first link 161, e.g., a radio link or a wired link. The first node 111 may communicate with each of the one or more second network nodes 122 over a respective second link 162, e.g., a radio link or a wired link. Only one of the respective second links 162 is depicted in FIG. 1 to simplify the figure. The first network node 120 may communicate, directly or indirectly, with each of the devices in the plurality of devices 130 over a respective third link 163, e.g., a radio link or a wired link. Only one of the respective third links 163 is depicted in FIG. 1 to simplify the figure. The first node 111 may communicate with the second node 112 over a fourth link 164, e.g., a radio link or a wired link. Any of the first link 161, the respective second link 162, the respective third link 163 and/or the fourth link 164 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 1.

In general, the usage of “first”, “second”, “third” and/or “fourth” herein may be understood to be an arbitrary way to denote different elements or entities, and may be understood to not confer a cumulative or chronological character to the nouns these adjectives modify.

Although terminology from LTE/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

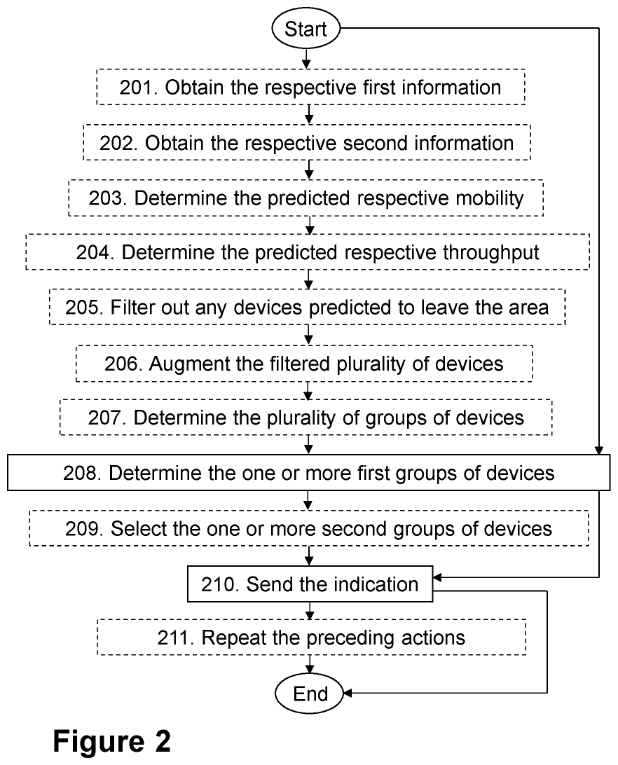

Embodiments of a computer-implemented method, performed by the first node 111, will now be described with reference to the flowchart depicted in FIG. 2. The method may be understood to be for handling groups of devices. The first node 111 operates in the communications system 100. The first network node 120 operates with a first communication access technology 101. The first communication technology 101 may be, e.g., a cellular technology such as LTE or NR.

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 111 is depicted in FIG. 2. In FIG. 2, optional actions in some embodiments may be represented with dashed lines.

### Action 201

In the course of operations of the communications system 100, the plurality of devices 130 served by the first network node 120 may move around and/or receive and/or send data or control information.

In this Action 201, the first node 111 may obtain, from the first network node 120, respective first information. The respective first information may be regarding respective mobility and throughput of the plurality of devices 130 served by the first network node 120.

Obtaining may be understood as e.g., receiving, e.g., via the first link 161.

The term “respective” may be understood to be used to denote that the first node 111 may obtain information, in this Action 201, first information, for every one of the devices comprised in the plurality of devices 130, that is, for each device, its own first information.

The mobility may indicate how mobile a device may be.

The respective first information regarding the respective mobility may be e.g., expressed as a <velocity, bearing>tuple. The respective first information regarding the respective mobility may comprise fine grained information of mobility, e.g., Global Positioning System (GPS) readings of latitude, longitude at timestamps, e.g., [Cell_ID, UE_ID, [latitude, longitude, timestamp], or more coarse-grained data, such as timestamped handovers of a respective device, and a target cell of every handover, e.g., [Target_cell_id, timestamp]. Such information may be understood to already exist in, for example, an Operations Administration and Management (OAM) node such as the Operations Support System (OSS).

The respective first information regarding the respective throughput may comprise the throughput of each device in uplink and downlink interface.

Both pieces of information may be provided as a timeseries. That is, in some embodiments, the respective first information may be obtained as a timeseries.

In this Action 201, the first node 111 may be understood to retrieve information about the devices that may be attached to a cell, e.g., served by the first network node 120.

The first node 111 may perform this Action 201 constantly in the background, e.g., periodically every X amount of time.

The obtained respective first information may be stored in a dataset buffer.

By obtaining the respective first information in this Action 201, the first node 111 may then be enabled to later identify which devices may need to be partially or completely offloaded from the first communication access technology 101, and to the second communication access technology 102, e.g., due to a traffic overload at the first network node 120.

### Action 202

In this Action 202, the first node 111 may obtain, from the set of second network nodes 121 comprising the one or more second network nodes 122, respective second information. The respective second information may be regarding a state of a respective wireless channel respectively served by the set of second network nodes 121. The one or more second network nodes 122 operate with a second communication access technology 102. The second communication technology 102 may be, e.g., a technology operating in unlicensed spectrum, such as WiFi.

Obtaining may be understood as e.g., receiving, e.g., via the respective second link 162.

That is, in this Action 202, the first node 111 may retrieve information about the current quality of the channel the one or more second network nodes 122, e.g., nearby AP or APs may be associated with. To retrieve this information, the one or more second network nodes 122 may be queried. The respective second information may concern consumed uplink and downlink throughput, but also theoretical capacity of the respective second network node 122. There may also be other measurements that may be considered, for example, number of devices, e.g., Stations (STAs), already connected, packet drop rate, latency, and round-trip-time. Other measurements may also consider device-provided signal to noise ratios.

The obtaining in this Action 202 may be performed, e.g., by an AP Channel State Buffer module within the first node 111.

By obtaining the respective second information in this Action 202, the first node 111 may be enabled to take into consideration the quality of the respective wireless channels when deciding how and if to perform the offloading of devices from the first communication access technology 101, and to the second communication access technology 102. The state of the respective wireless channel may be understood to be particularly relevant to ensure that any quality of service requirements the devices to be transferred may have, may be continued to be satisfied in the second communication access technology 102.

### Action 203

In some of embodiments, in this Action 203, the first node 111 may determine, based on the obtained respective first information, a predicted respective mobility of the plurality of devices 130 served by the first network node 120. In other words, the first node 111 may predict the mobility of each of the devices in the plurality of devices 130 at a certain future time period.

Determining may be understood as calculating, deriving, predicting, estimating or similar.

The determining in this Action 203 may be performed by using, for example, an algorithm that may calculate the haversine distance between two points measured, divided by their timestamp. This may then be used to calculate velocity, while bearing angle may also be calculated, using inverse trigonometric functions, see for example https://www.iqismap.com/what-is-bearinq-angle-and-calculate-between-two-points/. Based on the calculated velocity, the first node 111 may then be able to determine the respective mobility of the plurality of devices 130 at the future time period. That is, to determine the predicted respective mobility of the plurality of devices 130.

The determining of the predicted respective mobility in this Action 203 may be performed, e.g., by a mobility and throughput module within the first node 111.

In some embodiments, the predicted respective mobility may be determined using a first machine learning model. In some embodiments, the predicted respective mobility may be determined using a Long Short-Term Memory Network (LSTM).

The first node 111 may use the respective first information regarding mobility stored the dataset buffer to perform the determining in this Action 203.

By determining the predicted respective mobility of the plurality of devices 130 in this Action 203, the first node 111 may then be enabled to use this information to identify devices which may be ceasing to contribute to the load of the first network node 120, e.g., because they are on their way out of the area served by the first network node 120, and those devices which may be continuing to be a load for the first network node 120 at a certain time period in the future.

### Action 204

In this Action 204, the first node 111 may determine, based on the obtained respective first information, a predicted respective throughput of the plurality of devices 130 served by the first network node 120. In other words, the first node 111 may predict the throughput of each of the devices in the plurality of devices 130 at the certain future time period.

The determining in this Action 204 may be performed by using, for example, machine learning, linear regression, etc. In case more complex input is provided for a more accurate prediction, e.g., in addition to throughput, the time of day and date, the current capacity of the first network node 120, but also device characteristics that may affect throughput, such as battery rate of discharge and state of charge and power state of the device, a sequence to sequence neural network may be used. An example of such a network may be understood to be a long-short term memory network (LSTM). That is, in some embodiments, the predicted respective throughput may be determined using an LSTM.

The determining of the predicted respective throughput in this Action 204 may be performed, e.g., by the mobility and throughput module within the first node 111.

The first node 111 may use the respective first information regarding throughput stored the dataset buffer to perform the determining in this Action 203.

By determining the predicted respective throughput of the plurality of devices in this Action 204, the first node 111 may be enabled use this information to identify the respective contribution of the devices to the load of the first network node 120 and identify which devices may need to be offloaded from the first communication access technology 101 to the second communication access technology 102.

### Action 205

In this Action 205, the first node 111 may filter, based on the determined predicted respective mobility and the determined predicted respective throughput, any devices out of the plurality of devices 130 predicted to leave a serving area of the first network node 120. That is, the first node 111 may, based on the predicted respective mobility and respective throughput, be enabled to estimate which devices, out of the plurality of devices 130 currently served by the first network node 120, may no longer be served by the network node 121 at the certain future time period because they may be moving away from it, so that a filtered plurality of devices 150 may be used in further actions, as will be described later.

In some embodiments, the obtaining in Action 201 of the respective first information, the obtaining in Action 202 of the respective second information, the determining in Action 203 of the predicted respective mobility, the determining in Action 204 of the predicted respective throughput and the filtering in this Action 205 may be performed periodically.

By the first node 111 filtering any devices out of the plurality of devices 130 predicted to leave the serving area of the first network node 120 in this Action 205, the first node 111 may be enabled to identify which clusters of devices may be partially or completely transferred to the one or more second network nodes 122, e.g., the Wi-Fi AP or Wi-Fi APs, in proximity.

### Action 206

In this Action 206, the first node 111 may augment the filtered plurality of devices 150 that may have been obtained in Action 205 with third information. The third information may be regarding one or more respective policies of the devices comprised in the filtered plurality of devices 150.

A policy may be understood as a set of network requirements or rules that may specify how service may have to be provided to a device. The respective policies of the plurality of devices 130 may be stored, for example, in a UE policy repository of the communications system 100. As an example, the place where the QoS policy may be stored in a 3GPP network may be the Policy and Charging Rules Function (PCRF) in 4G networks or the Policy Control Function (PCF) in 5G networks. Policy and Charging Control (PCC) rules may be understood to specify QoS for devices in terms of priority, packet drop rate, guaranteed throughput and level of throughput and latency ceiling.

Augmenting may be understood as combining. The augmentation may be performed, e.g., per UE ID. As an example, the result may be a list <UE ID, predicted throughput, predicted mobility, priority, packet drop rate, guaranteed throughput, level of throughput, latency ceiling>.

By the first node 111 augmenting the filtered plurality of devices 150 with the third information in this Action 206, the first node 111 may be enabled to provide this information as input to an artificial neural network, as will be described in Action 208.

### Action 207

In this Action 207, the first node 111 may determine a plurality of groups of devices, that is the plurality of groups of devices 140. The first node 111 may determine the plurality of groups of devices 140 based on the obtained respective first information, the predicted respective mobility, the predicted respective throughput, and the one or more respective policies. Each of the groups in the plurality of groups of devices 140 may be a cluster.

Each of the groups of devices 151 in the plurality of groups of devices 140 has one or more respective policies pertaining to quality of service for device connection, e.g., QoS.

In some examples, any of the groups in the plurality of groups of devices may have one or more devices. In some examples, any of the groups in the plurality of groups of devices may have one or more devices with the proviso that at least one of the groups has more than one device.

The determining in this Action 207 may be performed by a clustering algorithm, such as hierarchical clustering, e.g., agglomerative methods.

The clustering algorithm may be understood to create classes, or “buckets”, of devices with different properties when in terms of their respective policies, e.g., QoS policies, and predicted consumption, also referred to herein as activity, that is, the obtained respective first information, the predicted respective mobility and the predicted respective throughput.

For example, the list <UE ID, predicted throughput, predicted mobility, priority, packet drop rate, guaranteed throughput, level of throughput, latency ceiling>obtained in Action 206 may be used as input to the clustering algorithm.

Some examples of groups of devices or clusters may be:

### Listing 1: Exemplary Clusters of Devices

<Highly Active [>=10 Mbps DIL, >=1 Mbps U/L], High Priority [1-4], Low Latency [<60 sec], Low Packet Drop Rate [<0.001%]>
<Moderately Active [5-10 MBps D/L, 0.5-1 M bps U/L], Medium Priority [5-8], Low Latency <60 sec], Low Packet Drop Rate [<0.001%]>
<Lowly Active [0-5 MBps D/L, 0-0.5 Mbps U/L], Low Priority [9], Low Latency [<60 sec], Low Packet Drop Rate [<0.001%]>
<Moderately Active [5-10 MBps D/L, 0.5-1 U/L], Medium Priority [5-8], Medium Latency [60-80 sec], Low Packet Drop Rate [<0.001%]>
[ . . . ]

The granularity of the clusters may differ, for example considering a “highly, medium, low” categorization as in the example above. Then, based on the number of features of considered for the cluster, which is 4 in the example above, that is: activity, priority, latency and packet drop rate, in total 81 combinations may be made. In general, X⁴, where X may be understood to be the number of categories and 4 may be understood to be the number of features used for the clustering.

Each group of devices or cluster may have its own population of devices stored in the memory of the first node 111.

By the first node 111 determining the plurality of groups of devices 140 in this Action 207, the first node 111 may then be able to plan a potential offloading of the devices from the first communication access technology 101 to the second communication access technology 102 based on their respective policies, while ensuring that such respective policies may be continued to be satisfied after the offloading, either at the first network node 120, or at the one or more second network nodes 122.

### Action 208

In this Action 208, the first node 111 determines, using machine learning, one or more first groups of devices, that is, the one or more first groups of devices 141, out of the plurality of groups of devices 140. The one or more first groups of devices 141 are to be transferred from the first network node 120 operating with the first communication access technology 101 to the one or more second network nodes 122 operating with the second communication access technology 102.

The plurality of devices 130 comprise the one or more first groups of devices 141.

As mentioned above, a group of devices may be understood as a cluster. In this Action 208, the first node 111 may aim to identify which clusters of devices may need to be partially or completely transferred to one or more second network nodes 122 operating with the second communication access technology 102, e.g., the Wi-Fi AP or Wi-Fi APs in proximity.

As explained earlier, each of the groups of devices 151 in the plurality of groups of devices 140 has the one or more respective policies pertaining to quality of service for device connection. The determining in this Action 208 is based on the one or more first groups of devices 141 having a highest probability, out of the plurality of groups of devices 140, to have their one or more respective policies satisfied in the second communication access technology 102.

Given the background information about the status of the first network node 120 and the channel quality, the process to transfer the one or more first groups of devices 141 may be triggered by an external event. The external event may be one of the following. According to a first option, a detection from the first network node 120 of a congestion event, for example current throughput reaching cell capacity or current number of active UE reaching limit of UE that may be supported on the cell. According to a second option, the external event may be a critical alarm detected at the first network node 120 that may include hardware failure, e.g., board failure but also cable failure, e.g., abnormally high bit error rate on Common Public Radio Interface (CPRI) connection between the radio unit and the baseband board, or Radio Frequency (RF) leakage on antenna and/or Radio Unit (RU) connectors, an issue with the power supply, e.g., fluctuating voltage on the power grid. According to a third option, the external event may be a trigger by the mobile network operator, e.g., for radio base station maintenance and/or upgrade. According to a fourth option, the external event may be a public safety/critical event such as a natural disaster or accident, detected for example by abnormal number of emergencies attach requests on the radio base station.

In some embodiments, the determining in this Action 208 may be further based on the obtained first information in Action 201 and the obtained respective second information in Action 202.

In some embodiments, the determining in this Action 208 may be further based on the predicted respective mobility in Action 203 and the predicted respective throughput in Action 204.

That the determining in this Action 208 may be further based on the predicted respective mobility and the predicted respective throughput may comprise excluding from the determining in this Action 208, the devices predicted to leave the serving area of the first network node 120, so that the filtered plurality of devices 150 may be used.

In some embodiments, the determining in this Action 208 may be further based on the augmented filtered plurality of devices 150.

The one or more first groups of devices 141 may be determined using an artificial neural network, such as a Deep-Q Network (DQN).

In some embodiments, the one or more first groups of devices 141 may be determined using a time series forecasting method.

In some embodiments, the artificial neural network may be trained with reinforcement learning (RL). Further details on the artificial neural network and the reinforcement training are provided below, in the description of Action 211.

The features of the cluster as shown above may be vectorized, together with the respective second information, e.g., the AP channel state information, and used as input to the DQN. The vector may also include a unique identifier of a group of devices or cluster, e.g., an integer such as clusterID. The DQN may have as output in this Action 208 the same 81 combinations, e.g., clusterIDs as discussed before and may indicate the cluster ID, or cluster IDs, that may be more likely to get transferred.

This Action 208 may be performed in an iteration, during the training of the artificial network, or, in a single instance, e.g., after a triggering event, during the execution of a mathematical model that may have been trained during the training, as will be described later, in relation to Action 211. In other words, although further description of this Action 208 may be provided in relation to Action 211, repetition of the method may be understood to not be required for performance of this Action 208. For example, the training may be performed by a different node, and then, the trained mathematical model may be provided to the first node 111 to perform this Action 208 during an operational phase.

By determining the one or more first groups of devices 141 in this Action 208, first node 111 may be enabled to identify the groups of devices that may need to be offloaded from the first communication access technology 101 to the second communication access technology 102 based on their respective policies, while ensuring that such respective policies may be continued to be satisfied after the offloading, either at the first network node 120, or at the one or more second network nodes 122.

Furthermore, for the embodiments wherein the artificial neural network may be trained, e.g., with RL, by determining the one or more first groups of devices 141 in this Action 208, first node 111 may be enabled to reduce the dimensions of the input and output space, making the artificial neural network independent to the number and identity of devices that may be currently attached to a cell. This may be understood to allow for faster training of an agent that may be performing the training, as well as better scalability to different types of environments.

### Action 209

In this Action 209, the first node 111 may select, from the determined one or more first groups of devices 141, one or more first devices 142 to transfer to the second communication access technology 102.

Once the first node 111 may have chosen the one or more first groups of devices 141, that is, a cluster or a number of clusters, the first node 111, e.g., using a UE selection function, may, in this Action 209, choose the one or more first devices 142 from one cluster ID, or the second likely cluster ID etc. if the first one does not have enough devices, to get transferred to the communication access technology 102. Different approaches may be taken in choice of devices from clusters, e.g., random, round robin or weighted round robin.

By the first node 111 selecting the one or more first devices 142 in this Action 209, the first node 111 may be enabled to transfers the devices which may have policies that may be predicted to be kept by the second communication access technology 102.

### Action 210

In this Action 210, the first node 111 sends an indication of the result of the determination in Action 208 to at least one of: the first network node 120, the one or more second network nodes 122, one or more of the devices 131, e.g., the one or more first devices 142, in the one or more first groups of devices 141 and another node 112 operating in the communications system 100.

In some embodiments, the sent indication may initiate the transfer of the one or more first devices 142 to the second communication access technology 102.

The indication may for example indicate that the one or more first devices 142 are to be transferred to the second communication access technology 102, e.g., an instruction to the first network node 120 to handover the devices, an instruction to allocate resources for the devices to the one or more second network nodes 122, or an instruction to the devices to handover to a respective second network node 112.

The sending in this Action 207 may be performed, e.g., via the first link 161 to the first network node 120, via a respective link to any of the one or more second network nodes 122 or the devices 131 in the one or more first groups of devices 141 and via the fourth link 164 to the another node 112.

The indication may, in some non-limiting implementations, correspond to an Initiate_Transfer function.

In a first group of non-limiting implementations, the indication may be ATSSS-based (release 16). The ATSSS feature introduced in [5], may allow a device simultaneous access to 3GPP NR and non-3GPP access such as Wi-Fi. ATSSS may depend on traffic rules stored in the Policy Control Function (PCF). For the uplink direction, the traffic rules may be distributed to the device and the User Plane Function (UPF). For the uplink direction, the device itself may steer/switch traffic generated by the device. In this case, the rules may be sent from the PCF via Session Management Function (SMF), when a multi-access session may be established. For the downlink direction, the User Plane Function (UPF) may be configured with a set of rules for either switching the traffic from e.g., new radio to Wi-Fi, or splitting the traffic between networks. As was also the case for the device, these rules may be communicated via SMF to UPF from PCF. Therefore, when considering an ATSSS-based option, the Initiate_Transfer function may first rewrite/edit/create rules in the PCF when it may come to the one or more first devices 142 being selected for transfer, to transfer both uplink and downlink function via Wi-Fi. The rules may then be enforced to uplink (UE) and downlink (Wi-Fi) via SMF. Note that this kind of signaling may be limited exclusively to 5G networks in such examples, 4G not supported. In case of ATSSS therefore, the agent for creating the rules may be a core network function, e.g., part of Network Data and Analytics Function (NWDAF), or PCF, communicating with OSS for data input and PCF for rule enforcement.

In a second group of non-limiting implementations, the indication may be LWA-based (release 13). For 4G networks, LTE-WLAN (LWA) aggregation may be used. LWA may be understood to follow the dual connectivity (DC) architecture. Specifically, LWA activation and de-activation and decision to which bearers may be offloaded from the first network node 120 to the second communication access technology 102, e.g., WLAN may be done by the first network node 120. In this case, and contrary to ATSSS, the first node 111 may be located within the first network node 120 or a local edge cloud

In a third group of non-limiting implementations, the indication may be based on the Wi-Fi Controller (WIC) or a similar product. Such a device may act as access controller for Wi-Fi and cellular and may be used by the “UE Throughput-Based Mobility to Wi-Fi” feature mentioned in the background section. In this case, the first node 111, e.g., a DQN agent, may be embedded in the product, making decisions on switching traffic from e.g., cellular to Wi-Fi, for UE belonging to clusters indicated by the first node 111.

By the first node 111 sending the indication in this Action 210, the first node 111 may enable to manage the offloading of devices from the first communication access technology 101 to the second communication access technology 102, considering the requirements of quality of service the devices may have.

### Action 211

In some embodiments, wherein the artificial neural network or the time series forecasting method may be trained with reinforcement learning, and wherein the respective first information and the respective second information are periodically updated, the first node 111 may, in this Action 211, repeat the preceding actions 201, 202, 203, 204, 205, 206, 207, 208, 209, 210. In these embodiments, in a training phase, an agent managed by the first node 111, in every iteration of a plurality of iterations of the repeating in this Action 211 may: i) observe the updated respective first information and respective second information as a respective state, ii) perform the determining in Action 204, of the predicted respective throughput and the determining in Action 203, of the predicted respective mobility with the updated first respective information, iii) performs the filtering in Action 205 based on the determined predicted respective mobility and the determined predicted respective throughput of the updated first respective information, iv) perform the augmenting in Action 206 on the filtered plurality of devices of the respective iteration, v) performs the determining in Action 207 of the plurality of groups of devices 140 for the respective iteration using the augmented filtered plurality of devices of the respective iteration, vi) performs the determining in Action 208 of the one or more first groups of devices 141 of the respective iteration, vii) select the one or more first devices 142 in Action 209 of the respective iteration, viii) take a respective action, as transfer of the one or more first devices 142 of the respective iteration for each respective state, ix) assess a respective effectiveness of the respective action as a respective reward indicating whether or not the one or more respective policies of the one or more first devices 142 of the respective iteration may have been satisfied in the second communication access technology 102, and x) train a mathematical model to maximize the respective effectiveness.

In an operational phase, e.g., once the mathematical model, for e.g., an ML model, may have been trained and achieved a desired accuracy or performance, an external event, as described earlier, may trigger the determining in Action 208 of the one or more first groups of devices 141 by the trained mathematical model, for e.g., a trained ML model.

During the operational phase, the trained ML model for e.g., a neural network, triggered by the external event may indicate which clusters of devices may be eligible for transfer. It may be important to note that the two phases may be interleaved ad inifinitum, as conditions around a neighborhood of a microcell of the first network node 120 and one or more proximal one or more second network nodes 122 may change over time. This is discussed further in the Section entitled “Training and Operation Phase Interleaving”.

That is, the operational phase may be understood to correspond to the execution of the trained mathematical model. This may be understood to be performed punctually, whereas, during the training phase, the method performed by the first node 111 may be performed iteratively.

The two phases as well as the reinforcement learning will now be described with further detail.

### RL Introduction

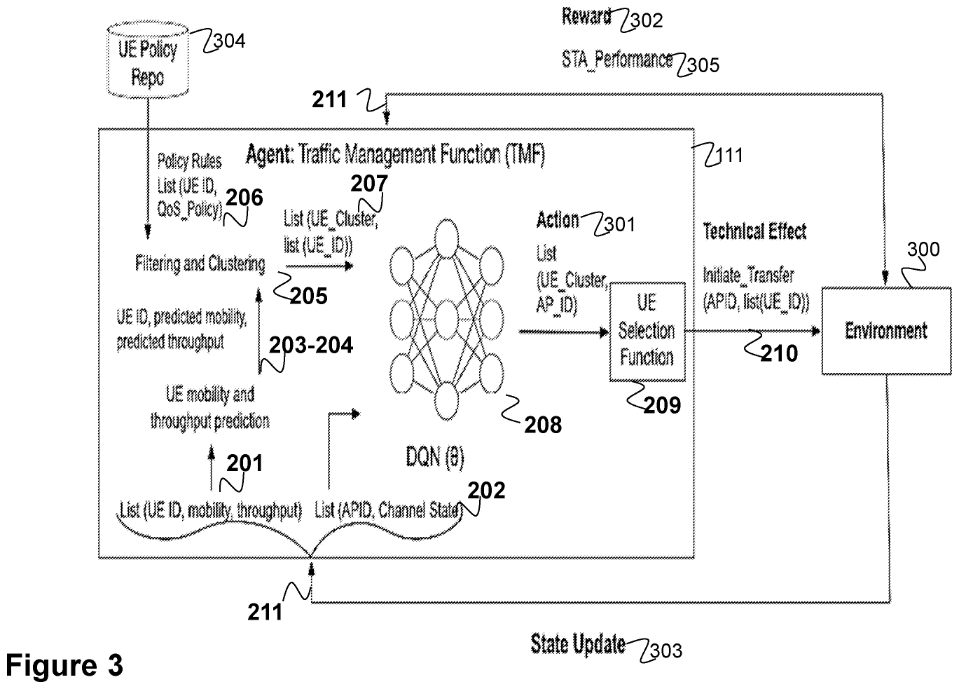

The training process may be implemented using single-agent RL run by the first node 111. To illustrate the description, this is schematically illustrated in FIG. 3. In the non-limiting example of FIG. 3, the single-agent is a Traffic Management Function (TMF). FIG. 3 particularly illustrates a non-limiting example of the training phase, wherein a single-agent RL loop using a Double Deep-Q learning algorithm. Specifically, an intelligent agent may observe updates from its environment 300 in what may be referred to as state. In any given state, the agent may take an action 301 in the environment, and the latter transitions to a new state. To assess the effectiveness of an action 301, a reward function, typically a scalar, may be also computed and returned by the environment 300. Over time therefore the agent may strive to learn the optimal policy, that is, the ability to take actions 301 that may maximize the reward 302 in any given state. The state-action-new state process may repeat until the agent may reach a final state or infinitely in absence of a final state.

In context of embodiments herein, there may be understood to be no such final state, and the learning may be considered to loop to converge when the agent may consistently learn to take effective actions, that is, the rate or reward acquisition may plateau and the reward may be consistently over a certain threshold. To mathematically formulate a single-agent reinforcement learning approach, the first node 111 may use a Markov decision process (MDP) with unknown transition probability.

Contrary to having the trained neural network of the agent take decisions per device, which may be understood to be expensive in terms of computational cost and time, may take an approach, wherein the size of the input and output space of the neural network may be reduced, by means of filtering, in Action 205, and clustering, in Action 207 and Action 208. The clustering process in particular may use both observations from the cell served by the first network node 120, but also from the QoS policies of the respective devices, which may be stored at the core network of the communications system 100. Reducing the dimensions of the input and output space and making the artificial neural network independent to the number and identity of the devices that may be currently attached to a cell may allow for faster training of the agent and better scalability to different types of environments.

### State Definition

The environment 300 may provide state updates 303 to the agent. First, in accordance with Action 202, an assessment of the channel state for every to second network node 122, e.g., access point, in proximity, as, for example, a list(APID, ChannelState), where the Access Point IDentifier (APID) may be understood to be a unique identifier of the second network node 122, such as a Media Access Control (MAC) address, or a Service Set Identifier (SSID). ChannelState may comprise consumed uplink and downlink throughput, but also theoretical capacity of the second network node 122. Optionally, other measurements may be considered, for example, number of STAs already connected, packet drop rate, latency, round-trip-time, and STA-provided signal to noise ratio.

Second, in accordance with Action 201, the activity of the plurality of devices 130 in a cell of the cellular network. This activity may be initially provided to the agent as a list of UE ID, mobility, and throughput. UE ID may be understood to be a unique identifier of a device, such as its international mobile subscriber identity (IMSI), the mobility, e.g., as explained before, may be, expressed as a <velocity, bearing>tuple, and throughput may be a time series of uplink and downlink rates over the observation period of the state update 303. Both mobility and throughput observations, as obtained in Action 201, may be used, in accordance with Action 203 and Action 204, as input to a machine learning model for providing future predictions, that is future mobility and throughput trends. The output list of <UE ID, predicted throughput, predicted mobility>may then be filtered in accordance with Action 205, and all UE ID that may have mobility indicating that they may leave the area of responsibility of the first node 111, e.g., of the TMF, may not be considered. An assumption here may be that the coverage of the one or more second network nodes 122 that the first node 111 may be responsible for may overlap the coverage of the cell served by the first network node 120 that the first node 111 may also be responsible for offloading its devices to the second communication access technology 102. Subsequently, the filtered list may be augmented, in accordance with Action 206, with information about the QoS policy of the respective devices. This information may be obtained from a UE policy repository 304 as, e.g, a list(UE ID, QoS_policy). As explained earlier, the list <UE ID, predicted throughput, predicted mobility, priority, packet drop rate, guaranteed throughput, level of throughput, latency ceiling>, may then be used, in accordance with Action 207, as input to a clustering algorithm. The output of this Action 207 may be, e.g., a List{UE_Cluster, list(UE_ID)}. As per previous, each cluster may have its own population of devices stored in the memory of the agent.

### Action Definition

The granularity of the clusters may differ, as stated earlier.

The features of the cluster as shown above may be vectorized, together with the respective second information obtained in Action 202 and used as input to the DQN “e” for performance of Action 208. The DQN may have as output the same 81 combinations, e.g., clusterIDs as discussed before and may indicate the cluster ID, or cluster IDs, which may be more likely to get transferred. This may be understood to be the action, that is, to propose candidate cluster(s) from which devices may be transferred to the second communication access technology 102. Therefore, considering a population of N clusters, N=81 with the 4 categories above, the action space in the simplest case may be:

$$A = \{ {a}_{1} [ {cluster}_{ID 1} ] , … {a}_{N} [ {cluster}_{IDN} ] \}$$

The above may be understood to presume that only one cluster may be selected. In a more general case, multiple clusters may be selected, and the size of the state space may be given by the binomial coefficient:

$$( \begin{matrix}n \\ k\end{matrix} ) = \frac{n !}{k ! \cdot ( n - k ) !}$$

which may be understood to indicate the number of ways that k outcomes may be picked from n possibilities.

Therefore, for example, if the first node 111 may want to choose 2 clusters out of the population of 81, then the size of the action space may be 3240. The selection may be, e.g., out of devices having similar characteristics.

Once an action may choose a cluster or a number of clusters, e.g, as a List (UE_Cluster, AP_ID), a device selection function may, in accordance with Action 209, choose the one or more first devices 142 from one cluster ID, or the second likely cluster ID etc. if the first one does not have enough devices, to get transferred to the second communication access technology 102, e.g., Wi-Fi, identified by their AP_IDs. Different approaches may be taken in choice of devices from clusters, e.g., random, round robin or weighted round robin. The first node 111 may then, in accordance with Action 210, send the indication to the environment 300 as an instruction to initiate transfer to the one or more second network nodes 122 identified by their APID, of the devices identified in the list (UE_ID).

### Reward Definition

The reward 302 may be understood to be a scalar which may indicate the effectiveness of the action chosen. A metric may be used for that purpose, which may be referred to herein as a STA performance 305 metric. The STA_performance 305 metric may produce a normalized [0, 1] value indicating how well did the agent perform against its respective policy, e.g., 3GPP QoS policy. As described above in the section entitled “State Definition”, in 3GPP a QoS policy for a device may be parametrized by one or more data flows, wherein each flow may have a latency ceiling, a packet drop rate threshold, a priority indicator and, optionally by a guaranteed throughput rate on the uplink and downlink. This information may be encapsulated in Policy Charging and Control (PCC) rules (see https://www.netmanias.com/en/?m=view&id=techdocs&no=10461). To calculate a reward for an action, which may involve a set of devices, the first node 111 may first define the STA_performance 305 for a single flow belonging to a single device, in case the flow includes guaranteed bitrate:

$${STA}_{{Performance}_{flowID , UEID}} = {w}_{lat} \cdot \frac{{\sum }_{i = 1}^{K} {lat}_{i}}{K} + {w}_{pcd} \cdot \frac{{\sum }_{i = 1}^{J} {pcd}_{i}}{J} + {w}_{thr} \cdot \frac{{\sum }_{i = 1}^{P} {thr}_{i}}{P} : {w}_{lat} + {w}_{pcd} + {w}_{thr} = 1$$

In the above formula, it may be assumed that during the monitoring period between the action taken and the reward returned, K latency values, J packet drop values and P throughput values may be sampled for this flow, normally, K=J=P, but there may be different sampling rates per metric. Here, it may be assumed that latency (lat), packet drop rate (pcd) and throughput (thr) metrics may be normalized, e.g., using minmax process:

$${lat}_{i} = \{ \begin{matrix}0 if {lat}_{i} > P C {C}_{latency} \\ \frac{{lat}_{i} - min ( lat )}{max ( lat ) - min ( lat )}\end{matrix} {pcd}_{i} = \{ \begin{matrix}0 if {pcd}_{i} > P C {C}_{pcd} \\ \frac{{pcd}_{i} - min ( pcd )}{max ( pcd ) - min ( pcd )}\end{matrix} {thr}_{i} = \{ \begin{matrix}0 if {thr}_{i} > P C {C}_{thr} \\ \frac{{thr}_{i} - min ( thr )}{max ( thr ) - min ( thr )}\end{matrix}$$

Note that in the above equation, throughput is expressed as an aggregate of both uplink and downlink. If a device, e.g., a UE, with ID X has K flows, then the STA_Performance 305 for UEₓ may be calculated as follows:

$${STA}_{{Performance}_{UEx}} = \frac{{\sum }_{i = 1}^{K} {STA}_{{Performance}_{{FLOW}_{i} , UEx}}}{K}$$

Finally, the reward that may consider J devices, e.g., referred to in the equation as UEi, chosen by the device selection function as described in the section entitled “Action Definition” may be formalized as follows:

$$r = \frac{{\sum }_{i = 1}^{J} {STA}_{{Performance}_{UEi}}}{J}$$

Note that there may be a variant of the above equation in case the device chosen by the device selection function may have a different priority. In that case, the reward may be a weighted average, instead of an average, of STA_Performance 305 metrics. The weights used may indicate bias towards those devices with higher relative priority than others, as described above, a minmax type of approach may be used to normalize the priorities.

### RL Algorithm Implementation

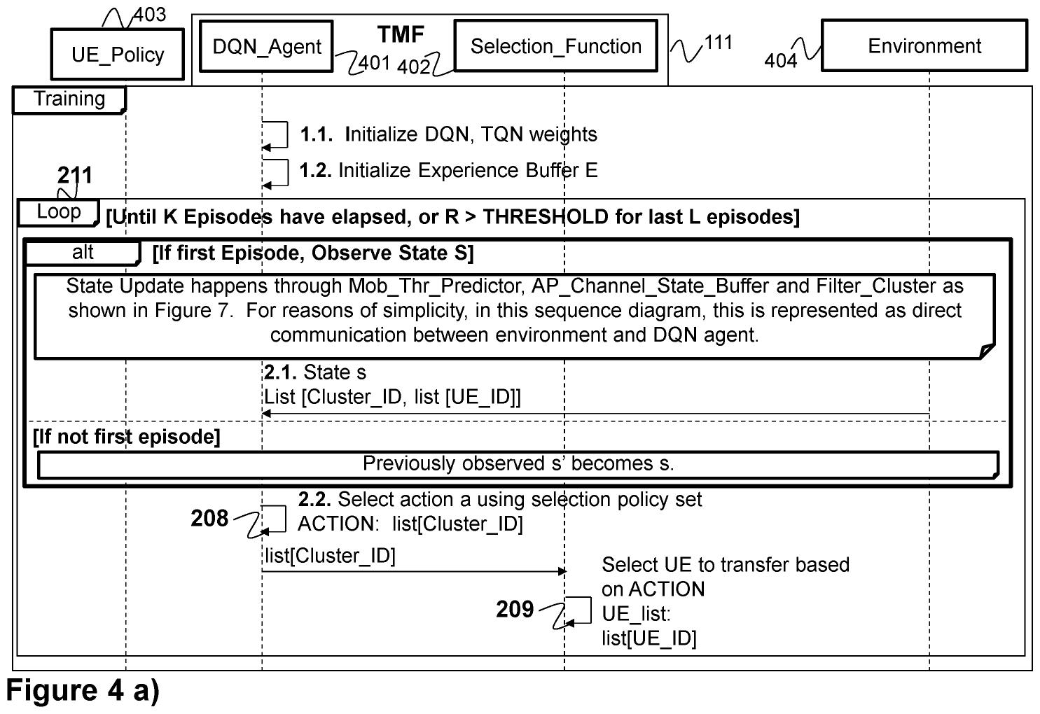

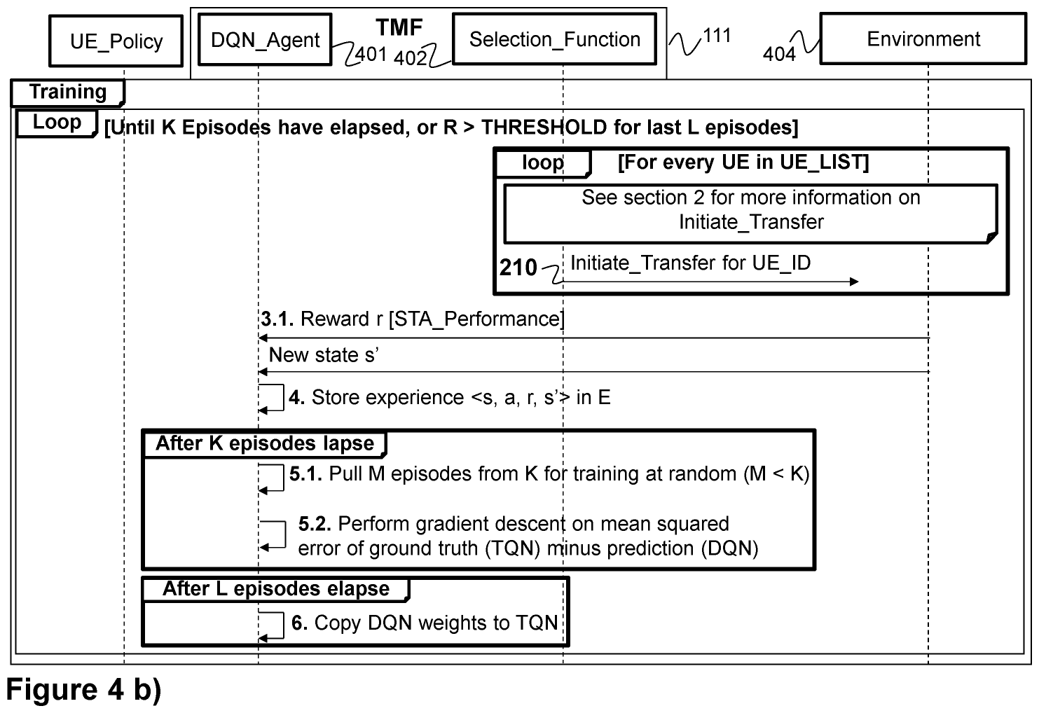

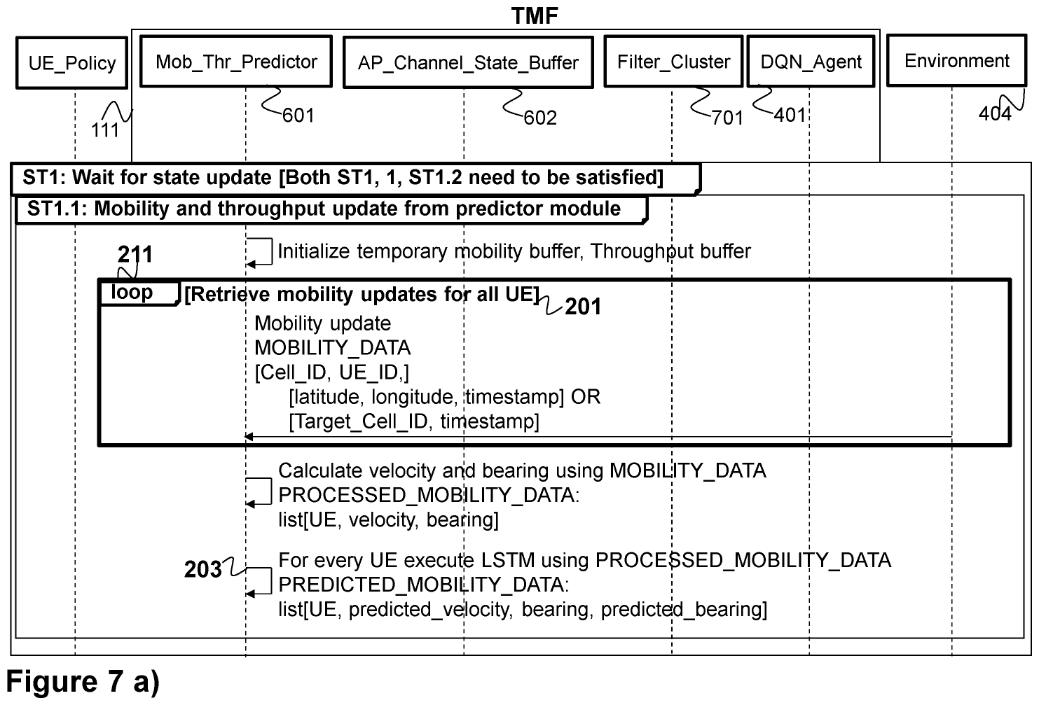

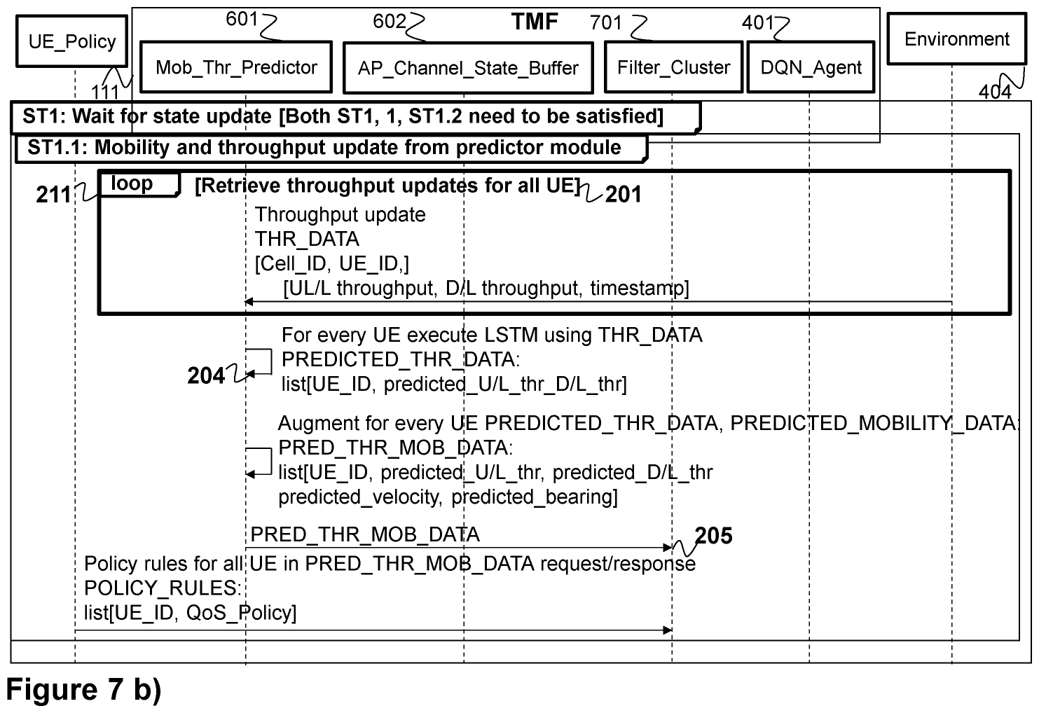

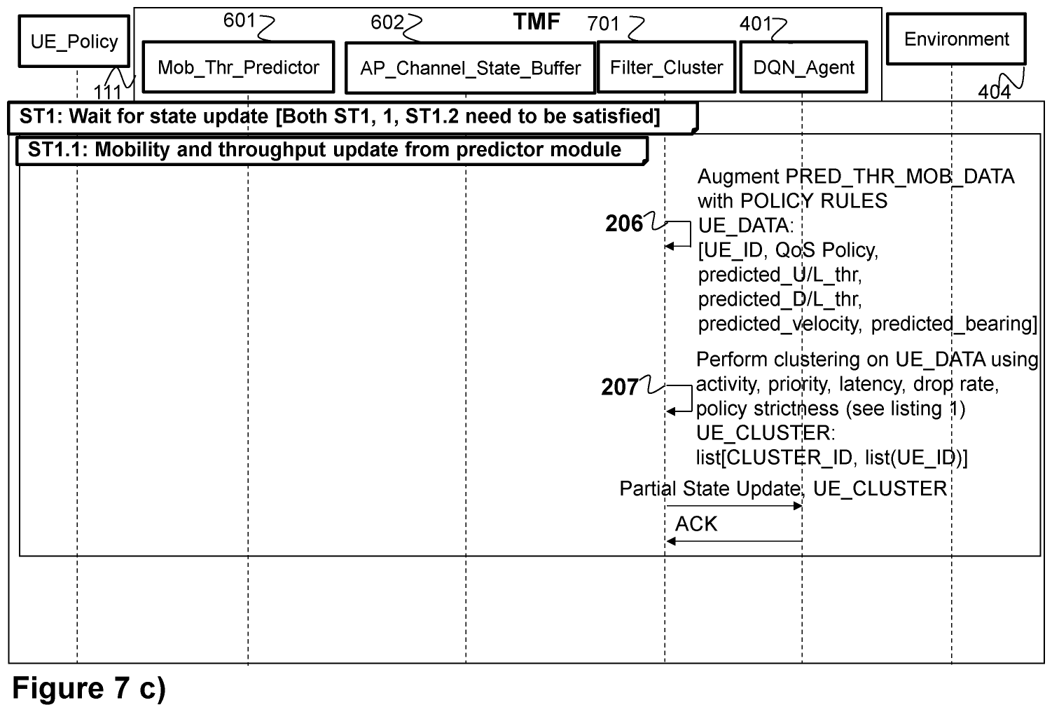

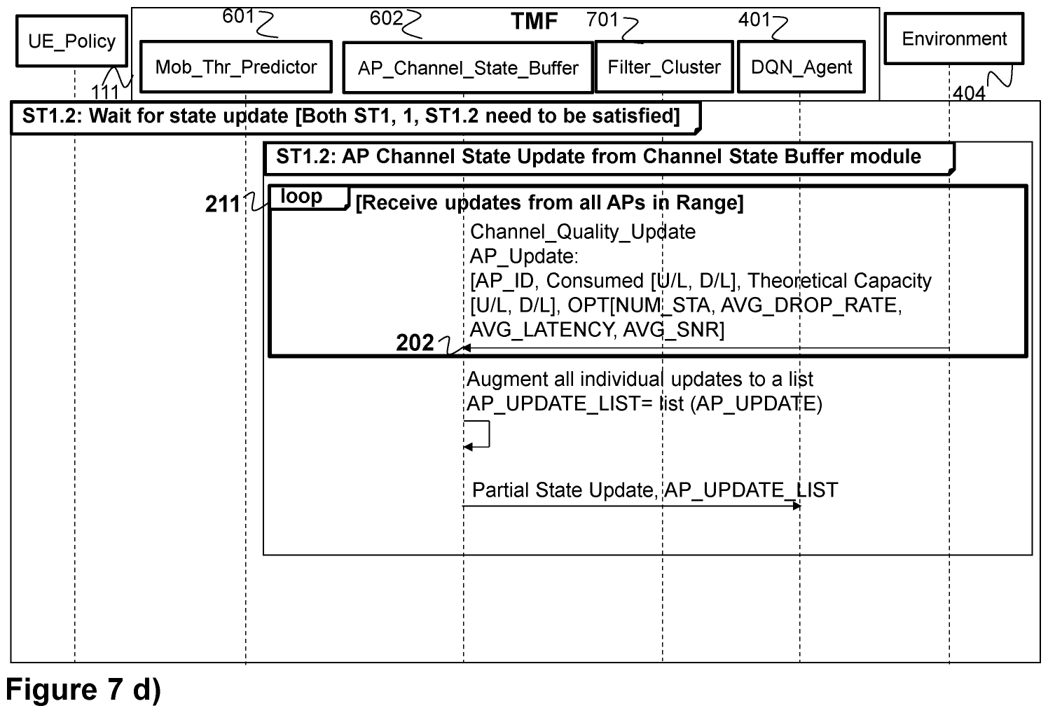

The first node 111 may implement the RL algorithm using a popular family of deep RL value learning algorithms known as Deep Q-Learning. Specifically, the first node 111 may use the double deep Q-learning variant. The process, during the training phase, may be, as schematically depicted in panel a) and panel b) of FIG. 4, as follows. In the non-limiting example of FIG. 4, the first node 111 is a TMF that comprises a DQN agent 401 and a selection function 402. The first node 111 may have access to a policy database, e.g., a UE_Policy 403. Initially, in Step1.1, the first node 111 may randomize the weights of the DQN, and a target network, e.g., a Target-Q Network (TQN) and may initialize in Step 1.2 an experience buffer E. The experience buffer E may be used to retain data to train the DQN. Subsequently, the first node 111 may enter an iterative stage, where the first step of every iteration, also known as episode, may be for the first node 111 to, given the current environment state obtained in Step 2.1, take an action “a” in Step 2.2. In the first episode, the state may be observed state “s”, whereas in subsequent episodes not being the first episode, a previously observed state “s′” may become state “s”. A state may be obtained as a List [Cluster ID, list [UE_ID]]. A State Update may be performed in every iteration by performing Actions 201-Acton 207, e.g., through Mob_Thr_Predictor, AP_Channel_State_Buffer and Filter_Cluster as shown in FIG. 7. For reasons of simplicity, in this sequence diagram, this is represented as a direct communication between environment 404 and the DQN agent 401. The environment 404 may comprise the first network node 120 and the set of second network nodes 121. In Step 2.2., the action “a” may be selected using a selection policy set. The action “a” may be understood to be to transfer a first set of one or more first groups of devices 141, e.g., a list[Cluster ID], determined in accordance with Action 208, to the one or more second network nodes 122. The first node 111 may then, e.g., via the selection function 402, select, in agreement with Action 209, a first set of the one or more first devices 142, based on the Action. The output may be a UE_list:list[UE_ID]. For every device, e.g., UE, in the first set of the one or more first devices 142, the first node 111 may, e.g., via the selection function 402, send, in accordance with Action 210, the indication to the environment 404 indicating to initiate the transfer to the respective first device 142, e.g., via Initiate_Transfer for UE_ID. Next, in Step 3.1, the first node 111 may observe the result of the action, that is, the reward “r”, as well as the next state “s′”. The reward in the case of embodiments herein may be understood to be an indication of whether the respective policy of the respective first device 142 was able to be fulfilled. The more cases of policy violations, the more the reward decreases. For example, in case latency is over the latency ceiling, this may count negative towards the reward. In Step 4, the first node 111 may store the experience in E, e.g., as <s, a, r, s′>. In Step 5, which may be understood to not be repeated for every episode, but after a few episodes, e.g., 100, have elapsed, the DQN may be trained selecting at 5.1 a set of random experiences from E as training data and using a training algorithm such as gradient descent at 5.2. At 5.1, the first node 111 may for example, pull M episodes from K for training at random (M<K). at 5.2, the loss function may use TQN as the ground truth, e.g., mean squared error (MSE) on TQN minus DQN prediction. Step 6 does not repeat either for every episode and may be more infrequent than step 5, e.g., after 1000 episodes elapsed. In this step, the TQN may copy DQN's weights. The TQN may be stable over the iterations, providing a consistent ground truth for the loss function. the previous steps loop until K Episodes may have elapsed, or

During the training phase, Steps 2 to 6 may repeat until a preset number of episodes “K” may be reached, e.g., 50.000, or until a reward acquisition rate may zero out and the reward “R” may consistently above a threshold. That is, R may exceed a given threshold for the last L episodes.

During the operational phase, the first node 111 may retrieve a state from the environment, preprocess the state to cluster devices as described previously, and execute its DQN, e.g., feed-forward pass, using the preprocessed state as input. The DQN may indicate the most suitable clusters for transfer and the first node 111 may then select the one or more first devices 142 from these clusters for transfer.

### Training and Operation Phase Interleaving

Throughout the lifetime of the system, it may be possible that the training and operation phases may be executed multiple times in succession. A training session may follow an operation session in case for example it may be concluded that the environment may have changed substantially in terms of device behavior and the DQN may need retraining to become more accurate.

The way inaccuracies of the model may be detected during operation may be to calculate the STA performance for at least a subset of randomly selected UE out of those chosen by the UE selection function, using the STA_Performance UE formula shown in the section entitled “RL algorithm implementation”. If that formula provides values consistently below a threshold, then a new training process may be triggered.

To enable this continual learning, without catastrophic interference, also known as catastrophic forgetting, during retrainings, only one part of the buffer may be replaced, while the rest may be kept intact with samples from previous training. This “intactness” may not need to last forever, e.g., it may be governed by a decay rate, which may over time remove “ancient” data but may keep old but still relevant data samples.

By the first node 111 repeating the preceding actions 201, 202, 203, 204, 205, 206, 207, 208, 209, 210 in this Action 211, the first node 111 may enable that various types of services with various QoS requirements may be offloaded from the first communication access technology 101 to the second communication access technology 102. Hence, the first node 111 may enable to alleviate the overload on the first communication access technology 101, e.g., the cellular system. As another advantage, the first node 111 may enable to improve the user quality of experience. The first devices 142 transferred to from the second communication access technology 102, e.g., WiFi, may keep their QoS, something not guaranteed by existing methods. Furthermore, the first node 111 may enable to improve the reliability, availability, and resiliency of the first communication access technology 101, e.g., the cellular network.

As yet another advantage, the first node 111 may enable that to achieve these advantages while using existing standards.

Further details on the method performed by the first node 111 as well will be described in the next Figures.

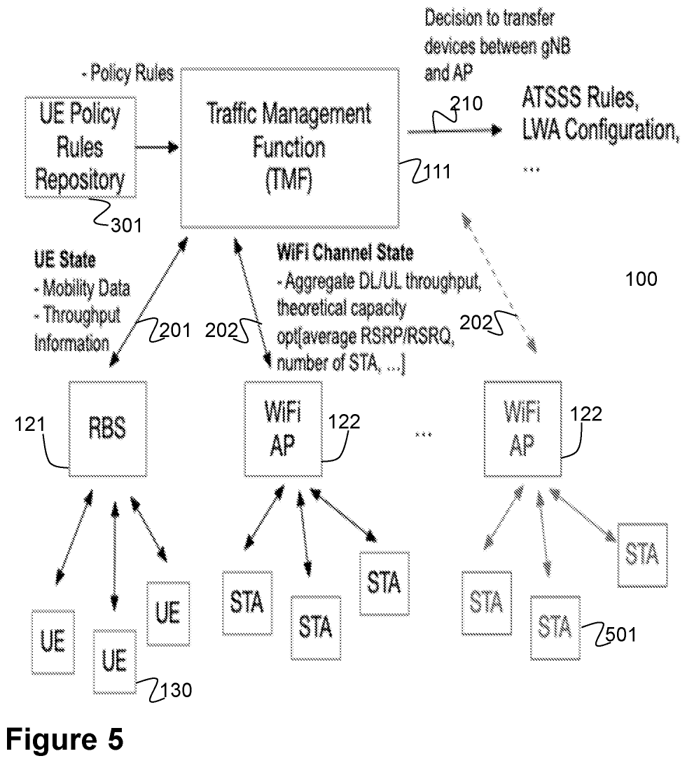

FIG. 5 is a schematic diagram illustrating a non-limiting example of a communications system 100 according to embodiments herein. Particularly, FIG. 5 illustrates the block components of the communications system 100. The first node 111 is depicted as a logical traffic management function (TMF), which is connected to both the first network node 120, a Radio Base Station (RBS) of the cellular network, such as an eNB or a gNB, and the set of second network nodes 120, in this example Wi-Fi APs. RBS may be understood to be a generic name that may encompass different generations of 3GPP cells. The first network node 120 serves the plurality of devices 130, which in this example are UEs. Each of the second network nodes 122 serves a respective plurality of STAs 501. In the background, the first node 111 may execute Actions 201 and 202 constantly in the background, e.g., periodically every X amount of time. In Action 201, the first node 111 may obtain the UE state as mobility data and throughput information. In Action 202, the first node 111 may obtain information on the WiFi channel state as an aggregate of DL/UL throughput, theoretical capacity of the respective second network node 122, and optionally average of Reference Signal Received Power (RSRP)/Reference Signal Received Quality (RSRQ), number of STA, etc. The first node 111 may also obtain the one or more respective policies from the UE policy rules repository 304. The first node 111 may then, send the indication indicating its decision to transfer devices between the first network node 120, e.g., a gNB, and the one or more second network nodes 122, e.g., APs. The indication may be or comprise, e.g., ATSSS rules, an LTE-WLAN (LWA) configuration, etc. . . .

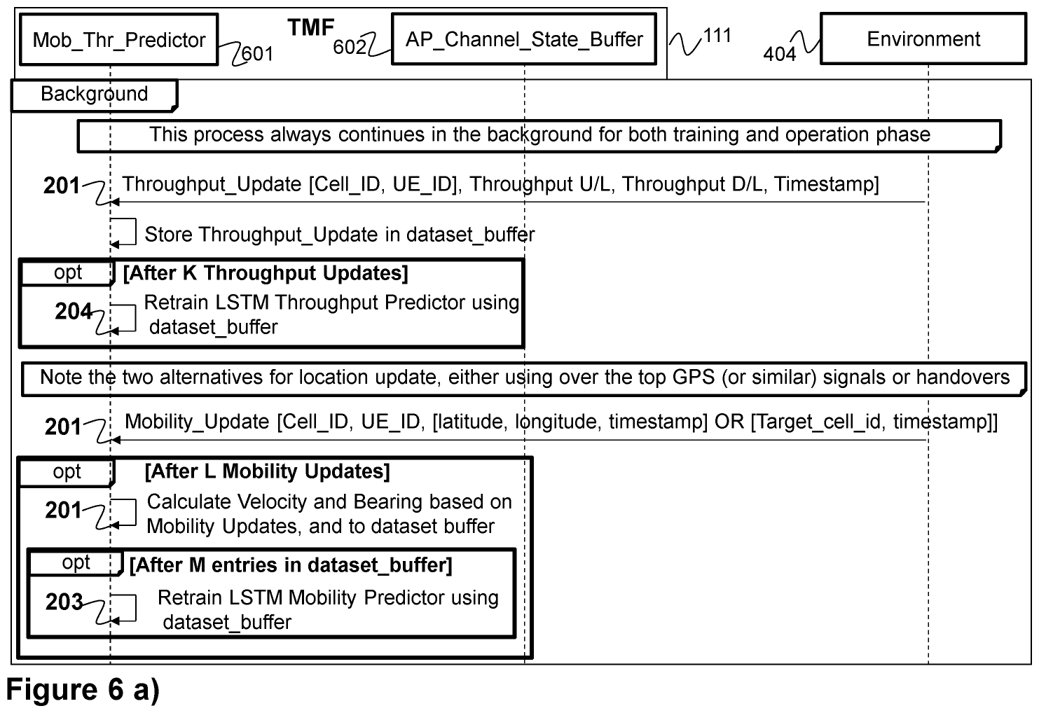

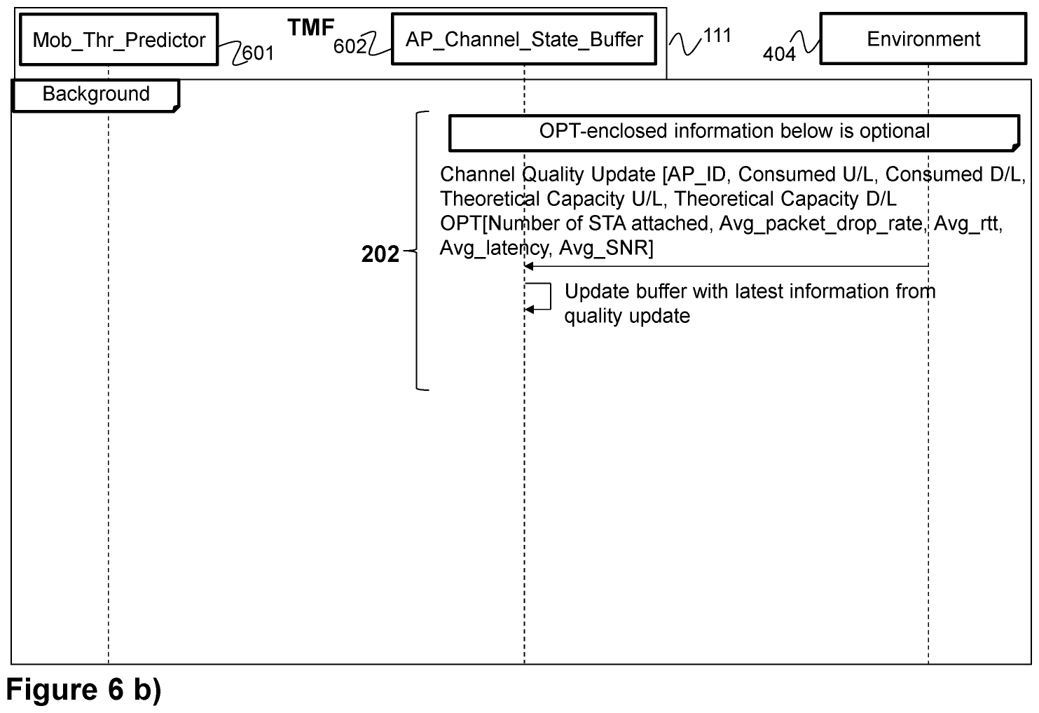

FIG. 6 is a signalling diagram illustrating a non-limiting example of the method performed by the first node 111, according to embodiments herein. Particularly, FIG. 6 depicts the background operations that may be performed. This process may be continuously performed in the background for both training and operation phase. In this example, the first node 111 comprises a mobility and throughput predictor (Mob_Thr_Predictor) 601 and an AP Channel State Buffer (AP_Channel_State_Buffer) 602. Starting in panel a) of FIG. 6, According to Action 201, the Mob_Thr_Predictor 601 may receive from the environment 404 the respective first information as a Throughput_Update [Cell_ID, UE_ID], Throughput U/L, Throughput D/L, Timestamp]. The first Mob_Thr_Predictor 601 may then store the throughput update in the dataset buffer. Optionally, e.g., after K throughput updates, the Mob_Thr_Predictor 601 may retrain the LSTM throughput predictor according to Action 204, using the dataset buffer. It may be noted that there may be two alternatives for location update, either using over the top GPS, or similar, signals or handovers. Also according to Action 201, the Mob_Thr_Predictor 601 may receive from the environment 404 the respective first information as a Mobility_Update [Cell_ID, UE_ID, [latitude, longitude, timestamp] OR [Target_cell_id, timestamp]]. Optionally, e.g., after L mobility updates, the Mob_Thr_Predictor 601 may, also according to Action 201, calculate velocity and bearing based on mobility updates, and may store them in the dataset buffer. Also optionally, e.g., after M entries in the dataset buffer, the Mob_Thr_Predictor 601 may, according to Action 203, retrain the LSTM Mobility Predictor using the dataset_buffer. Continuing in panel b) of FIG. 6, the AP_Channel_State_Buffer 602 may optionally, in accordance with Action 202, receive from the environment 404 the respective second information as a Channel Quality Update [AP_ID, Consumed U/L, Consumed D/L, Theoretical Capacity U/L, Theoretical Capacity D/L, which may optionally further include the [Number of STA attached, Avg_packet_drop_rate, Avg_rtt, Avg_latency, Avg_SNR]. The AP_Channel_State_Buffer 602 may then update the buffer with the latest information from the quality update.

FIG. 7 is a signalling diagram illustrating a non-limiting example of the training process according to embodiments herein. While FIG. 4 illustrated the overall procedure, FIG. 7 illustrates details on the state update operation, which was also previously described. It is assumed here that the Mob_Thr_Predictor 601 and AP_Channel_State_Buffer 602 as shown in FIG. 6 have already been trained. In this example, the first node 111 further comprises the DQN agent 401, and a Filter Cluster 701. Starting on panel a) of FIG. 7, during a first stage (ST1), the first node 111 may wait for a state update until both stage 1.1. (ST1.1) and stage 1.2 (ST1.2), which will be described next may be satisfied. During ST1.1, the first node 111 may obtain the mobility and throughput update from the predictor module, Mob_Thr_Predictor 601. The process may start by initializing a temporary mobility buffer and a throughput buffer. Next, looping in accordance with Action 211, the first node 111 may, in accordance with Action 201, retrieve mobility updates for the plurality of devices 130, e.g., all UEs served by the first network node 120. This may be performed by receiving from the environment 404 a Mobility update as MOBILITY_DATA [Cell_ID, UE_ID,][latitude, longitude, timestamp] OR [Target_Cell_ID, timestamp]. Based on the obtained respective first information, the Mob_Thr_Predictor 601 may then calculate the velocity and bearing using MOBILITY_DATA, PROCESSED_MOBILITY_DATA:list[UE, velocity, bearing]. Then, in accordance with Action 203, the Mob_Thr_Predictor 601 may, for every device, e.g., UE, execute LSTM using PROCESSED_MOBILITY_DATA obtain PREDICTED_MOBILITY_DATA:list[UE, predicted_velocity, bearing, predicted_bearing]. Continuing in panel b) of FIG. 7, during ST1.1, looping in accordance with Action 211, the first node 111 may, in accordance with Action 201, retrieve throughput updates for the plurality of devices 130, e.g., all UEs served by the first network node 120. This may be performed by receiving from the environment 404 a Throughput update as THR_DATA[Cell_ID, UE_ID,][UL/L throughput, D/L throughput, timestamp]. Based on the obtained respective first information, the Mob_Thr_Predictor 601 may then, in accordance with Action 204, for every device, e.g., UE, execute LSTM using THR_DATA to obtain the PREDICTED_THR_DATA:list[UE_ID, predicted_U/L_thr_D/L_thr]. Next, the Mob_Thr_Predictor 601 may, for every device, e.g., UE, Augment the PREDICTED_THR_DATA, PREDICTED_MOBILITY_DATA:PRED_THR_MOB_DATA: with list[UE_ID, predicted_U/L_thr, predicted_D/L_thr predicted_velocity, predicted_bearing]. Then, the filter cluster 701, in accordance with Action 205 may, based on the determined predicted respective mobility and the determined predicted respective throughput, e.g., the PRED_THR_MOB_DATA provided by the Mob_Thr_Predictor 601, filter any devices out of the plurality of devices 130 predicted to leave the serving area of the first network node 120. The filter cluster 701 may obtain the policy rules for all UE in PRED_THR_MOB_DATA request/response as POLICY_RULES:list[UE_ID, QoS_Policy]. Continuing in panel c) of FIG. 7, the filter cluster 701 may then, in accordance with Action 206, augment the PRED_THR_MOB_DATA with POLICY RULES as UE_DATA: [UE_ID, QoS Policy, predicted_U/L_thr,predicted_D/L_thr,predicted_velocity, predicted_bearing]. The filter cluster 701 may next, in accordance with Action 207, perform clustering on UE_DATA using activity, priority, latency, drop rate, policy strictness (see listing 1) UE_CLUSTER: list[CLUSTER_ID, list(UE_ID)]. The filter cluster 701 may then provide a partial state update for the UE_Cluster to the DQN agent401, which the DQN agent 401 may acknowledge back to the filter cluster 701. Continuing in panel d) of FIG. 7, during ST1.2, looping in accordance with Action 211, the first node 111 may, in accordance with Action 202, receive updates from all APs in Range. The respective second information may be received as Channel_Quality_Update comprising AP_Update:[AP_ID, Consumed [U/L, D/L], Theoretical Capacity [U/L, D/L], OPT[NUM_STA, AVG_DROP_RATE, AVG_LATENCY, AVG_SNR]. The AP_Channel_State_Buffer 602 may then augment all individual updates to a list AP_UPDATE_LIST=list (AP_UPDATE), and send a Partial State Update, e.g., as an AP_UPDATE_LIST, to the DQN agent 401

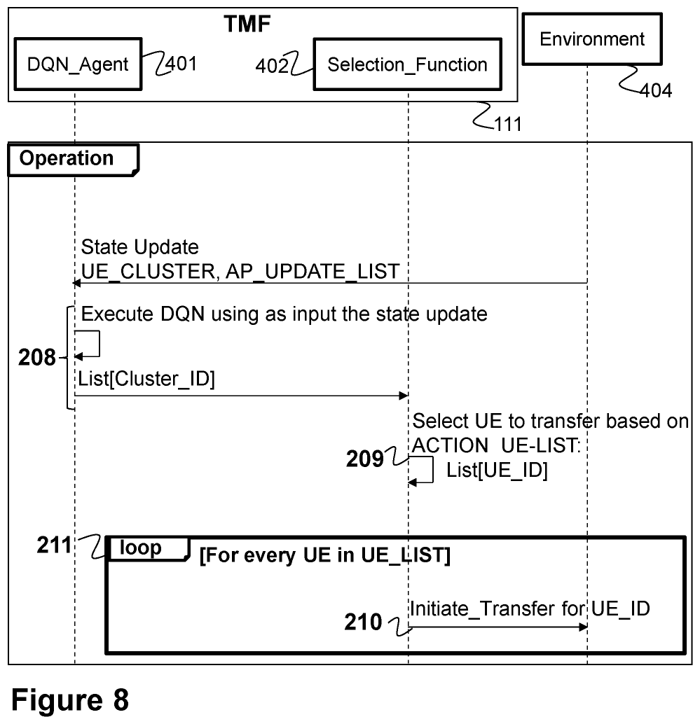

FIG. 8 is a signalling diagram illustrating a non-limiting example of the operational phase, according to embodiments herein. During the operational phase, the DQN agent 401 within the first node 111 may receive state updates. See FIG. 7 for more information on state extraction. Particularly, the DQN agent 401 may receive a State Update as a UE_CLUSTER, AP_UPDATE_LIST. The DQN agent 401 may then execute the DQN using as input the state update, in accordance with Action 208. The DQN agent 401 may then output a List[Cluster_ID] which it may then provide to the selection function 402 comprised in the first node 111. The selection function 402 may then select devices, e.g., UEs to transfer based on the ACTION UE-LIST:List[UE_ID]. Finally, looping in accordance with Action 211, the first node 111 may send the indication to the environment 404 in accordance with Action 210, to initiate the transfer of the selected one or more first devices 142 by sending an instruction to Initiate_Transfer for UE_ID of the selected one or more first devices 142.

As a summarized overview of the foregoing, embodiments herein may be understood to enable offloading of cellular network from devices of different QoS types, that is, “policies”, to Wi-Fi, by means of machine learning. Embodiments herein may use a clustering-based approach to reduce complexity of and stabilizing input size of the neural network trained by means of deep RL, as opposed to performing a computationally expensive decision on a device per device basis.

Certain embodiments disclosed herein may provide one or more of the following technical advantage(s), which may be summarized as follows. As a first advantage, embodiments herein may be understood to enable that various types of services with various QoS requirements may be offloaded from cellular network to WiFi.

As a further advantage, embodiments herein may enable to alleviate the overload on the cellular system. As another advantage, embodiments herein may for example enable to improve the user quality of experience. As an additional advantage, this may be understood to improve the reliability, availability, and resiliency of the cellular network.

As yet another advantage, embodiments herein may enable that UEs transferred to WiFi may keep their QoS, something not guaranteed by existing methods. Moreover, embodiments herein may function using existing standards.

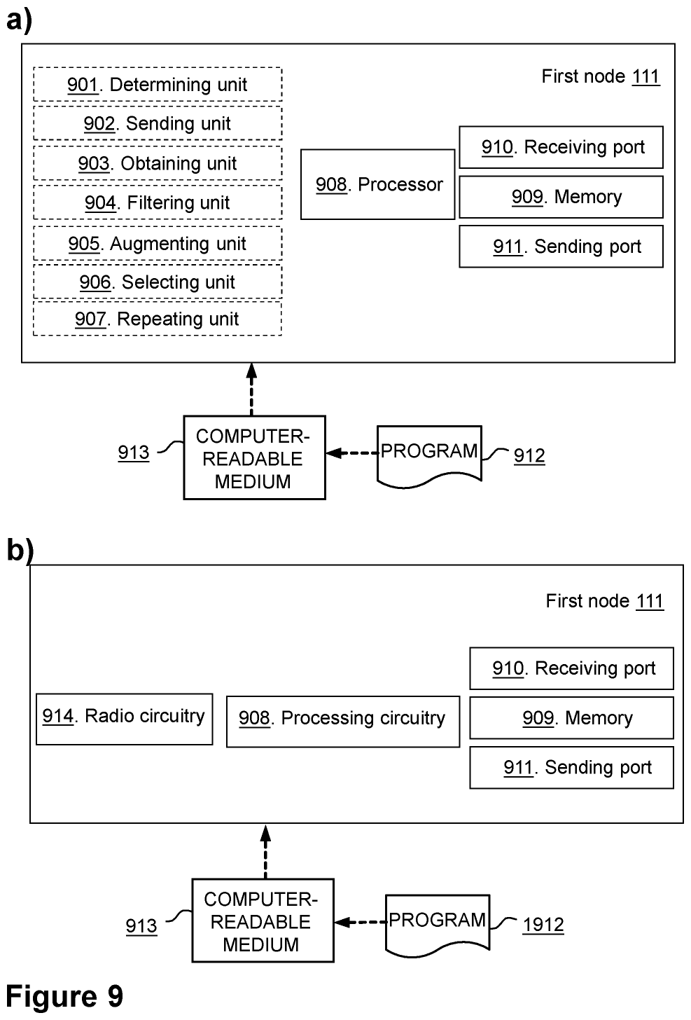

FIG. 9 depicts two different examples in panels a) and b), respectively, of the arrangement that the first node 111 may comprise to perform the method actions described above in relation to FIG. 2, and/or FIGS. 3-8. In some embodiments, the first node 111 may comprise the following arrangement depicted in FIG. 9a. The first node 111 may be understood to be for handling groups of devices. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 9, optional boxes are indicated by dashed lines. The detailed description of some of the following corresponds to the same references provided above, in relation to the actions described for the first node 111 and will thus not be repeated here. For example, the first communication access technology 101 may be cellular, e.g., LTE or 5G and the second communication access technology 102 may be WiFi.

The first node 111 is configured to, e.g. by means of a determining unit 901 within the first node 111 configured to, determine, using machine learning, the one or more first groups of devices 141, out of the plurality of groups of devices 140, to be transferred from the first network node 120 configured to operate with the first communication access technology 101 to the one or more second network nodes 122 configured to operate with the second communication access technology 102. Each of the groups of devices 151 in the plurality of groups of devices 140 is configured to have the one or more respective policies configured to pertain to quality of service for device connection. The determining of the one or more first groups of devices 141 is configured to be based on the one or more first groups of devices 141 having the highest probability, out of the plurality of groups of devices 140, to have their one or more respective policies satisfied in the second communication access technology 102.

The first node 111 is also configured to, e.g. by means of a sending unit 902 within the first node 111 configured to, send the indication of the result of the determination to at least one of: the first network node 120, the one or more second network nodes 122, the one or more of the devices 131 in the one or more first groups of devices 141 and the another node 112 configured to operate in the communications system 100.

The first node 111 may be further configured to, e.g. by means of an obtaining unit 903 within the first node 111 configured to, obtain, from the first network node 120, the respective first information regarding the respective mobility and the throughput of the plurality of devices 130 configured to be served by the first network node 120. The plurality of devices 130 may be configured to comprise the one or more first groups of devices 141.

In some embodiments, the first node 111 may be further configured to, e.g. by means of the obtaining unit 903 within the first node 111 configured to, obtain, from the set of second network nodes 121 configured to comprise the one or more second network nodes 122, the respective second information regarding the state of the respective wireless channel respectively served by the set of second network nodes 121. In some of such embodiments, the determining of the one or more first groups of devices 141 may be configured to be further based on the first information configured to be obtained and the respective second information configured to be obtained.

In some embodiments, the first node 111 may be further configured to, e.g. by means of the determining unit 901 within the first node 111 configured to, determine, based on the respective first information configured to be obtained, the predicted respective mobility of the plurality of devices 130 configured to be served by the first network node 120.

In some embodiments, the first node 111 may be further configured to, e.g. by means of the determining unit 901 within the first node 111 configured to, determine, based on the respective first information configured to be obtained, the predicted respective throughput of the plurality of devices 130 configured to be served by the first network node 120. In some of such embodiments, the determining of the one or more first groups of devices 141 may be configured to be further based on the predicted respective mobility and the predicted respective throughput.

In some embodiments, the first node 111 may be further configured to, e.g. by means of a filtering unit 904 within the first node 111 configured to, filter, based on the predicted respective mobility configured to be determined and the predicted respective throughput configured to be determined, any devices out of the plurality of devices 130 configured to be predicted to leave the serving area of the first network node 120. That the determining of the one or more first groups of devices 141 may be further configured to be based on the predicted respective mobility and the predicted respective throughput may be configured to comprise excluding from the determining of the one or more first groups of devices 141, the devices configured to be predicted to leave the serving area of the first network node 120, so that the filtered plurality of devices 150 may be configured to be used.

In some embodiments, the first node 111 may be further configured to, e.g. by means of an augmenting unit 905 within the first node 111 configured to, augment the filtered plurality of devices 150 with the third information regarding the one or more respective policies of the devices configured to be comprised in the filtered plurality of devices 150. In some of such embodiments, the determining of the one or more first groups of devices 141 may be configured to be further based on the augmented filtered plurality of devices 150.

In some embodiments, the first node 111 may be further configured to, e.g. by means of the determining unit 901 within the first node 111 configured to, determine the plurality of groups of devices 140 based on the respective first information configured to be obtained, the predicted respective mobility, the predicted respective throughput, and the one or more respective policies. Each of the groups in the plurality of groups of devices 140 may be configured to be a cluster.

In some embodiments, the first node 111 may be further configured to, e.g. by means of a selecting unit 906 within the first node 111 configured to, select, from the determined one or more first groups of devices 141, the one or more first devices 142 to transfer to the second communication access technology 102. In some of such embodiments, the sent indication may be configured to initiate the transfer of the one or more first devices 142 to the second communication access technology 102.

In some embodiments, at least one of the following may apply: a) the predicted respective mobility may be configured to be determined using an LSTM, b) the predicted respective throughput may be configured to be determined using an LSTM, c) the one or more first groups of devices 141 may be configured to be determined using the artificial neural network, d) the one or more first groups of devices 141 may be configured to be determined using the time series forecasting first node 111, e) the artificial neural network may be configured to be trained with reinforcement learning, f) the respective first information may be configured to be obtained as a timeseries, and g) the obtaining of the respective first information, the obtaining of the respective second information, the determining of the predicted respective mobility, the determining of the predicted respective throughput and the filtering may be configured to be performed periodically.

In some embodiments, wherein the artificial neural network or the time series forecasting first node 111 may be configured to be trained with reinforcement learning, and wherein the respective first information and the respective second information may be configured to be periodically updated, the first node 111 may be further configured to, e.g. by means of a repeating unit 907 within the first node 111 configured to, repeat the preceding actions 201, 202, 203, 204, 205, 206, 207, 208, 209, 210 the first node 111 may be configured to perform, and wherein: a) in a training phase, the agent configured to be managed by the first node 111, in every iteration of the plurality of iterations of the repeating may be configured to: i) observe the updated respective first information and respective second information as a respective state, ii) perform the determining of the predicted respective throughput and the determining of the predicted respective mobility with the updated first respective information, iii) perform the filtering based on the predicted respective mobility configured to be determined and the predicted respective throughput configured to be determined of the updated first respective information, iv) perform the augmenting on the filtered plurality of devices of the respective iteration, v) perform the determining of the plurality of groups of devices for the respective iteration using the augmented filtered plurality of devices of the respective iteration, vi) perform the determining of the one or more first groups of devices 141 of the respective iteration, vii) select the one or more first devices 142 of the respective iteration, viii) take a respective action, as transfer of the one or more first devices 142 of the respective iteration for each respective state, ix) assess the respective effectiveness of the respective action as the respective reward indicating whether or not the one or more respective policies of the one or more first devices 142 of the respective iteration may have been satisfied in the second communication access technology 102, and x) train the mathematical model to maximize the respective effectiveness; and b) in an operational phase, the external event may be configured to trigger the determining of the one or more first groups of devices 141 by the mathematical model configured to be trained,

The embodiments herein may be implemented through one or more processors, such as a processor 908 in the first node 111 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 909 comprising one or more memory units. The memory 909 is arranged to be used to store obtained information, store data, configurations, schedulings, and applications etc. to perform the methods herein when being executed in the first node 111.

In some embodiments, the first node 111 may receive information from, e.g., the first network node 120, the one or more second network nodes 122, any of the devices in the plurality of devices 130, the another node 112 and/or another node or device, through a receiving port 910. In some examples, the receiving port 910 may be, for example, connected to one or more antennas in the first node 111. In other embodiments, the first node 111 may receive information from another structure in the communications system 100 through the receiving port 910. Since the receiving port 910 may be in communication with the processor 908, the receiving port 910 may then send the received information to the processor 908. The receiving port 910 may also be configured to receive other information.

The processor 908 in the first node 111 may be further configured to transmit or send information to e.g., the first network node 120, the one or more second network nodes 122, any of the devices in the plurality of devices 130, the another node 112, another node or device, and/or another structure in the communications system 100, through a sending port 911, which may be in communication with the processor 908, and the memory 909.

Those skilled in the art will also appreciate that any of the units 901-907 described above may refer to a combination of analog and digital circuits, and/or one or more processors configured with software and/or firmware, e.g., stored in memory, that, when executed by the one or more processors such as the processor 908, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 901-907 described above may be the processor 908 of the first node 111, or an application running on such processor.

Thus, the methods according to the embodiments described herein for the first node 111 may be respectively implemented by means of a computer program 912 product, comprising instructions, i.e., software code portions, which, when executed on at least one processor 908, cause the at least one processor 908 to carry out the actions described herein, as performed by the first node 111. The computer program 912 product may be stored on a computer-readable storage medium 913. The computer-readable storage medium 913, having stored thereon the computer program 912, may comprise instructions which, when executed on at least one processor 908, cause the at least one processor 908 to carry out the actions described herein, as performed by the first node 111. In some embodiments, the computer-readable storage medium 913 may be a non-transitory computer-readable storage medium, such as a CD ROM disc, a memory stick, or stored in the cloud space. In other embodiments, the computer program 912 product may be stored on a carrier containing the computer program, wherein the carrier is one of an electronic signal, optical signal, radio signal, or the computer-readable storage medium 913, as described above.

The first node 111 may comprise an interface unit to facilitate communications between the first node 111 and other nodes or devices, e.g., the first network node 120, the one or more second network nodes 122, any of the devices in the plurality of devices 130, the another node 112, another node or device, and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 9b. The first node 111 may comprise a processing circuitry 908, e.g., one or more processors such as the processor 908, in the first node 111 and the memory 909. The first node 111 may also comprise a radio circuitry 914, which may comprise e.g., the receiving port 910 and the sending port 911. The processing circuitry 908 may be configured to, or operable to, perform the method actions according to FIG. 2, and/or FIGS. 3-8, in a similar manner as that described in relation to FIG. 9a. The radio circuitry 914 may be configured to set up and maintain at least a wireless connection with the first network node 120, the one or more second network nodes 122, any of the devices in the plurality of devices 130, the another node 112, another node or device, and/or another structure in the communications system 100.

Hence, embodiments herein also relate to the first node 111 operative for handling groups of devices, the first node 111 being operative to operate in the communications system 100. The first node 111 may comprise the processing circuitry 908 and the memory 909, said memory 909 containing instructions executable by said processing circuitry 908, whereby the first node 111 is further operative to perform the actions described herein in relation to the first node 111, e.g., in FIG. 2, and/or FIGS. 3-8.

When using the word “comprise” or “comprising”, it shall be interpreted as non-limiting, i.e. meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

[1] Bin Liu, Qi Zhu, Weiqiang Tan, Hongbo Zhu, “Congestion-Optimal WiFi Offloading with User Mobility Management in Smart Communications”, Wireless Communications and Mobile Computing, vol. 2018, Article ID 9297536, 15 pages, 2018. https://doi.org/10.1155/2018/9297536
[2]B. H. Jung, N.-o. Song and D. K. Sung, “An energy-efficient WiFi offloading model in a heterogeneous network,” 2014 IEEE Online Conference on Green Communications (OnlineGreenComm), 2014, pp. 1-5, doi: 10.1109/OnlineGreenCom.2014.7114433.
[3] Chun-Chuan Yang, Jeng-Yueng Chen, Yi-Ting Mai, Yi-Chih Wang, “Delay-Sensitive Network Selection and Offloading in LTE-A and Wi-Fi Heterogeneous Networks”, Journal of Circuits, Systems and Computers (IF1.333), Pub Date: 2020 Dec. 16, DOI: 10.1142/s0218126621501206
[4]G. Fortetsanakis and M. Papadopouli, “How beneficial is the WiFi offloading?A detailed game-theoretical analysis in wireless oligopolies,” 2016 IEEE 17th International Symposium on A World of Wireless, Mobile and Multimedia Networks (WoWMoM), 2016, pp. 1-10, doi: 10.1109/WoWMoM.2016.7523504.
[5]3rd Generation Partnership Project; Technical Specification Group Core Network and Terminals; 5G System; Access Traffic Steering, Switching and Splitting (ATSSS); Stage 3 (Release 17)
[6]3GPP, Collaboration on LTE—WLAN Integration, https://www.3gpp.org/news-events/3gpp-news/1771-wlan_lte
[7] UE Throughput-Based Mobility to Wi-Fi, https://cpistore.internal.ericsson.com/elex?LI=EN/LZN7931071*&CL=EN/LZN7931040*&FN=1 61_22104-LZA7016014_1Uen.*.html&DT=UE+Throughput-Based+Mobility+to+W-Fi.

1. A computer-implemented method, performed by a first node, the method being for handling groups of devices, the first node operating in a communications system, the method comprising:
determining, using machine learning, one or more first groups of devices, out of a plurality of groups of devices, to be transferred from a first network node operating with a first communication access technology to one or more second network nodes operating with a second communication access technology, wherein each of the groups of devices in the plurality of groups of devices has one or more respective policies pertaining to quality of service for device connection, and wherein the determining is based on the one or more first groups of devices having a highest probability, out of the plurality of groups of devices, to have their one or more respective policies satisfied in the second communication access technology; and
sending an indication of the result of the determination to at least one of: the first network node, the one or more second network nodes, one or more of the devices in the one or more first groups of devices and another node operating in the communications system.

2. The method according to claim 1, further comprising:
obtaining, from the first network node, respective first information regarding respective mobility and throughput of a plurality of devices served by the first network node, the plurality of devices comprising the one or more first groups of devices; and
obtaining, from a set of second network nodes comprising the one or more second network nodes, respective second information regarding a state of a respective wireless channel respectively served by the set of second network nodes,
wherein the determining is further based on the obtained first information and the obtained respective second information.

3. The method according to claim 2, further comprising:
determining, based on the obtained respective first information, a predicted respective mobility of the plurality of devices served by the first network node; and
determining, based on the obtained respective first information, a predicted respective throughput of the plurality of devices served by the first network node,
wherein the determining is further based on the predicted respective mobility and the predicted respective throughput.

4. The method according to claim 3, further comprising:
filtering, based on the determined predicted respective mobility and the determined predicted respective throughput, any devices out of the plurality of devices predicted to leave a serving area of the first network node, and wherein that the determining is further based on the predicted respective mobility and the predicted respective throughput comprises excluding from the determining the devices predicted to leave the serving area of the first network node, so that a filtered plurality of devices is used.

5. The method according to claim 4, further comprising:
augmenting the filtered plurality of devices with third information regarding the one or more respective policies of the devices comprised in the filtered plurality of devices, and
wherein the determining is further based on the augmented filtered plurality of devices.

6. The method according to claim 3, further comprising:
determining the plurality of groups of devices based on the obtained respective first information, the predicted respective mobility, the predicted respective throughput, and the one or more respective policies, and wherein each of the groups in the plurality of groups of devices is a cluster.

7. The method according to claim 1, further comprising:
selecting, from the determined one or more first groups of devices, one or more first devices to transfer to the second communication access technology, and
wherein the sent indication initiates the transfer of the one or more first devices to the second communication access technology.

8. The method according to claim 3, wherein at least one of:
a. the predicted respective mobility is determined using a Long Short-Term Memory Network,
b. the predicted respective throughput is determined using a Long Short-Term Memory Network,
c. the one or more first groups of devices are determined using an artificial neural network,
d. the one or more first groups of devices are determined using a time series forecasting method,
e. the artificial neural network is trained with reinforcement learning,
f. the respective first information is obtained as a timeseries, and
g. the obtaining of the respective first information, the obtaining of the respective second information, the determining of the predicted respective mobility, the determining of the predicted respective throughput and the filtering are performed periodically.

9. The method according to claim 5, wherein the artificial neural network or the time series forecasting method is trained with reinforcement learning, wherein the respective first information and the respective second information are periodically updated, and wherein the method further comprises:
repeating (i) the obtaining of the respective first information, (ii) the obtaining of the respective second information, (iii) the determining of the predicted respective mobility, (iv) the determining of the predicted respective throughput, (v) the filtering, (vi) the augmenting, (vii) determining the plurality of groups of devices based on the obtained respective first information, the predicted respective mobility, the predicted respective throughput, and the one or more respective policies, and wherein each of the groups in the plurality of groups of devices is a cluster, (viii) the determining one or more first groups of devices to be transferred, (ix) selecting, from the determined one or more first groups of devices, one or more first devices to transfer to the second communication access technology, and (x) the sending, and wherein:
a. in a training phase, an agent managed by the first node, in every iteration of a plurality of iterations of the repeating:
i. observes the updated respective first information and respective second information as a respective state,
ii. performs the determining, of the predicted respective throughput and the determining, of the predicted respective mobility with the updated first respective information,
iii. performs the filtering based on the determined predicted respective mobility and the determined predicted respective throughput of the updated first respective information,
iv. performs the augmenting on the filtered plurality of devices of the respective iteration,
v. performs the determining of the plurality of groups of devices for the respective iteration using the augmented filtered plurality of devices of the respective iteration
vi. performs the determining of the one or more first groups of devices of the respective iteration,
vii. selects the one or more first devices of the respective iteration,
viii. takes a respective action, as transfer of the one or more first devices of the respective iteration for each respective state,
ix. assesses a respective effectiveness of the respective action as a respective reward indicating whether or not the one or more respective policies of the one or more first devices of the respective iteration have been satisfied in the second communication access technology, and
x. trains a mathematical model to maximize the respective effectiveness,
b. in an operational phase, an external event triggers the determining of the one or more first groups of devices by the trained mathematical model.

10. A first node, for handling groups of devices, the first node being configured to operate in a communications system, the first node being further configured to:
determine, using machine learning, one or more first groups of devices, out of a plurality of groups of devices, to be transferred from a first network node configured to operate with a first communication access technology to one or more second network nodes configured to operate with a second communication access technology, wherein each of the groups of devices in the plurality of groups of devices is configured to have one or more respective policies configured to pertain to quality of service for device connection, and wherein the determining of the one or more first groups of devices is configured to be based on the one or more first groups of devices having a highest probability, out of the plurality of groups of devices, to have their one or more respective policies satisfied in the second communication access technology; and
send an indication of the result of the determination to at least one of: the first network node, the one or more second network nodes, one or more of the devices in the one or more first groups of devices and another node configured to operate in the communications system.

11. The first node according to claim 10, being further configured to:
obtain, from the first network node, respective first information regarding respective mobility and throughput of a plurality of devices configured to be served by the first network node, the plurality of devices being configured to comprise the one or more first groups of devices; and
obtain, from a set of second network nodes configured to comprise the one or more second network nodes, respective second information regarding a state of a respective wireless channel respectively served by the set of second network nodes,
wherein the determining of the one or more first groups of devices is configured to be further based on the first information configured to be obtained and the respective second information configured to be obtained.

12. The first node according to claim 11, being further configured to:
determine, based on the respective first information configured to be obtained, a predicted respective mobility of the plurality of devices configured to be served by the first network node; and
determine, based on the respective first information configured to be obtained, a predicted respective throughput of the plurality of devices configured to be served by the first network node,
wherein the determining of the one or more first groups of devices is configured to be further based on the predicted respective mobility and the predicted respective throughput.

13. The first node 1 according to claim 12, being further configured to:
filter, based on the predicted respective mobility configured to be determined and the predicted respective throughput configured to be determined, any devices out of the plurality of devices configured to be predicted to leave a serving area of the first network node, and wherein that the determining of the one or more first groups of devices is further configured to be based on the predicted respective mobility and the predicted respective throughput is configured to comprise excluding from the determining of the one or more first groups of devices, the devices configured to be predicted to leave the serving area of the first network node, so that a filtered plurality of devices is configured to be used.

14. The first node according to claim 13, being further configured to:
augment the filtered plurality of devices with third information regarding the one or more respective policies of the devices configured to be comprised in the filtered plurality of devices, and
wherein the determining of the one or more first groups of devices is configured to be further based on the augmented filtered plurality of devices.

15. The first node according to claim 12, being further configured to:
determine the plurality of groups of devices based on the respective first information configured to be obtained, the predicted respective mobility, the predicted respective throughput, and the one or more respective policies, and wherein each of the groups in the plurality of groups of devices is configured to be a cluster.

16. The first node according to claim 10, being further configured to:
select, from the determined one or more first groups of devices, one or more first devices to transfer to the second communication access technology, and
wherein the sent indication is configured to initiate the transfer of the one or more first devices to the second communication access technology.

17. The first node according to claim 12, wherein at least one of:
a. the predicted respective mobility is configured to be determined using a Long Short-Term Memory Network,
b. the predicted respective throughput is configured to be determined using a Long Short-Term Memory Network,
c. the one or more first groups of devices are configured to be determined using an artificial neural network,
d. the one or more first groups of devices are configured to be determined using a time series forecasting first node,
e. the artificial neural network is configured to be trained with reinforcement learning,
f. the respective first information is configured to be obtained as a timeseries, and
g. the obtaining of the respective first information, the obtaining of the respective second information, the determining of the predicted respective mobility, the determining of the predicted respective throughput and the filtering are configured to be performed periodically.

18. The first node according to claim 14, wherein the artificial neural network or the time series forecasting first node is configured to be trained with reinforcement learning, wherein the respective first information and the respective second information are configured to be periodically updated, and wherein the first node is further configured to:
repeat the (i) the obtain the respective first information, (ii) the obtain the respective second information, (iii) the determine the predicted respective mobility, (iv) the determine the predicted respective throughput, (v) the filter, (vi) the augment, (vii) determine the plurality of groups of devices based on the obtained respective first information, the predicted respective mobility, the predicted respective throughput, and the one or more respective policies, and wherein each of the groups in the plurality of groups of devices is a cluster, (viii) the determine one or more first groups of devices to be transferred, (ix) select, from the determined one or more first groups of devices, one or more first devices to transfer to the second communication access technology, and (x) the send the first node is configured to perform, and wherein:
a. in a training phase, an agent configured to be managed by the first node, in every iteration of a plurality of iterations of the repeating is configured to:
i. observe the updated respective first information and respective second information as a respective state,
ii. perform the determining of the predicted respective throughput and the determining of the predicted respective mobility with the updated first respective information,
iii. perform the filtering based on the predicted respective mobility configured to be determined and the predicted respective throughput configured to be determined of the updated first respective information,
iv. perform the augmenting on the filtered plurality of devices of the respective iteration,
v. perform the determining of the plurality of groups of devices for the respective iteration using the augmented filtered plurality of devices of the respective iteration,
vi. perform the determining of the one or more first groups of devices of the respective iteration,
vii. select the one or more first devices of the respective iteration,
viii. take a respective action, as transfer of the one or more first devices of the respective iteration for each respective state,
ix. assess a respective effectiveness of the respective action as a respective reward indicating whether or not the one or more respective policies of the one or more first devices of the respective iteration have been satisfied in the second communication access technology, and
x. train a mathematical model to maximize the respective effectiveness,
b. in an operational phase, an external event is configured to trigger the determining of the one or more first groups of devices by the mathematical model configured to be trained.

19. A computer program product, comprising instructions which, when executed on at least one processor, cause the at least one processor to carry out operations comprising:
determine, using machine learning, one or more first groups of devices, out of a plurality of groups of devices, to be transferred from a first network node operating with a first communication access technology to one or more second network nodes operating with a second communication access technology, wherein each of the groups of devices in the plurality of groups of devices has one or more respective policies pertaining to quality of service for device connection, and wherein the determining is based on the one or more first groups of devices having a highest probability, out of the plurality of groups of devices, to have their one or more respective policies satisfied in the second communication access technology; and
send an indication of the result of the determination to at least one of: the first network node, the one or more second network nodes, one or more of the devices in the one or more first groups of devices and another node operating in the communications system.

20. A non-transitory computer-readable storage medium, having stored thereon a computer program, comprising instructions which, when executed on at least one processor, cause the at least one processor to carry out operations comprising:
determine, using machine learning, one or more first groups of devices, out of a plurality of groups of devices, to be transferred from a first network node operating with a first communication access technology to one or more second network nodes operating with a second communication access technology, wherein each of the groups of devices in the plurality of groups of devices has one or more respective policies pertaining to quality of service for device connection, and wherein the determining is based on the one or more first groups of devices having a highest probability, out of the plurality of groups of devices, to have their one or more respective policies satisfied in the second communication access technology; and
send an indication of the result of the determination to at least one of: the first network node, the one or more second network nodes, one or more of the devices in the one or more first groups of devices and another node operating in the communications system.
